(19) United States
(12) Patent Application Publication
(10) Pub. No.: US 2026/0332049 A1
(43) Pub. Date: Oct. 22, 2026

(54) POWER CONVERTER AND CONTROLLING METHOD THEREOF

(71) Applicant: OmniOn Power Technology GmbH, Baden (CH)

(72) Inventors: Lei Wang, Shanghai City (CN); Tom Sun, Shanghai City (CN); Rui Wu, Shanghai City (CN); Xiaojian Zhao, Shanghai City (CN)

(21) Appl. No.: 19/323,014

(22) Filed: Sep. 9, 2025

(30) Foreign Application Priority Data
Apr. 16, 2025 (CN) 202510476022.3

(51) Int. Cl. H02M 3/155

(52) U.S. Cl. CPC H02M 3/155

(57) ABSTRACT

A power convertor, comprising: a first switch coupled to an input power source, the input power source configured to generate an input current; a second switch coupled to the input power source; a third switch coupled to the first switch; a fourth switch coupled to the second switch; and a plurality of inductances coupled to each of the first switch, the second switch, the third switch, and the fourth switch, wherein when the second switch is turned off and the fourth switch is turned on, the third switch is turned off, and when each of the first switch, the third switch and the fourth switch is turned on, the plurality of inductances generate an output current according to the input current to provide power to a load.

### CROSS-REFERENCE TO RELATED APPLICATION(S)

This application claims priority to China Application Serial Number 202510476022.3, filed on April 16, 2025, which is herein incorporated by reference.

### BACKGROUND

### Technical Field

The present disclosure relates to a power converter. More particularly, the present disclosure relates to a power converter and controlling method thereof.

### Description of Related Art

As the cloud computing and application of artificial intelligent have developed, the demand of high-power mainboard constantly increases. The bus voltage level of the mainboard of the sever in a data service center is generally 54 volts, and thus the needs of a power converter converting from 54 volts to 12 volts increased. In the power supplying system of the server, the bus voltage of the mainboard is not fixed. Instead, the bus voltage is varying within a certain range. In order to get 12 volts of fixed output voltage, a power converter having a wider voltage regulation gain is required.

### SUMMARY

The present disclosure provides a power converter. The power converter comprises a first switch coupled to an input power source, input power source configured to generate an input current signal; a second switch coupled to the input power source; a third switch coupled to the first switch; a fourth switch coupled to the second switch; and a plurality of inductors coupled to each of the first switch, the second switch, the third switch, and the fourth switch, wherein when the second switch is turned off, and the fourth switch is turned on, the third switch is turned off, and when each of the first switch, the third switch, and the fourth switch is turned on, the plurality of the inductors generate an output current signal according to the input current signal to provide power to a load.

The present disclosure provides a method for controlling a power converter. The method comprises turning on a first switch and a second switch coupled to an input power source to generate an input current signal; turning on a third switch coupled to the first switch, configured to charge a first capacitor and a second capacitor; when the second switch being turned off, and when a fourth switch coupled to the second switch being turned on, turning off the third switch; and when each of the first switch, the third switch, and when the fourth switch being turned on, an output current signal is generated to provide power to a load according to the input current signal.

The present disclosure provides a power converter. The power converter comprises a first switch coupled to an input power source, the input power source configured to generate an input current signal; a second switch coupled to the input power source; a third switch coupled to each of the first switch and the second switch; a fourth switch coupled to the second switch; and a fifth switch coupled to the first switch, wherein when the first switch is turned off, and when the fifth switch is turned on, the third switch is turned off, and when each of the first switch, the third switch, and the fourth switch is turned on, an output current signal is generated by a plurality of the inductors according to the input current signal.

It is to be understood that both the foregoing general description and the following detailed description are by examples, and are intended to provide further explanation of the disclosure as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a circuit diagram of a power converter, illustrated in accordance with some embodiments of the present disclosure.

FIG. 2 is a timing diagram of controlling a power converter, illustrated in accordance with some embodiments of the present disclosure.

FIG. 3A is a circuit diagram of a power converter, illustrated in accordance with some embodiments of the present disclosure.

FIG. 3B is a circuit diagram of a power converter, illustrated in accordance with some embodiments of the present disclosure.

FIG. 3C is a circuit diagram of a power converter, illustrated in accordance with some embodiments of the present disclosure.

FIG. 3D is a circuit diagram of a power converter, illustrated in accordance with some embodiments of the present disclosure.

FIG. 3E is a circuit diagram of a power converter, illustrated in accordance with some embodiments of the present disclosure.

FIG. 3F is a circuit diagram of a power converter, illustrated in accordance with some embodiments of the present disclosure.

FIG. 4 is a circuit diagram of a power converter, illustrated in accordance with some embodiments of the present disclosure.

FIG. 5A is a circuit diagram of a power converter, illustrated in accordance with some embodiments of the present disclosure.

FIG. 5B is a circuit diagram of a power converter, illustrated in accordance with some embodiments of the present disclosure.

FIG. 5C is a circuit diagram of a power converter, illustrated in accordance with some embodiments of the present disclosure.

FIG. 5D is a circuit diagram of a power converter, illustrated in accordance with some embodiments of the present disclosure.

FIG. 5E is a circuit diagram of a power converter, illustrated in accordance with some embodiments of the present disclosure.

FIG. 5F is a circuit diagram of a power converter, illustrated in accordance with some embodiments of the present disclosure.

FIG. 6 is a circuit diagram of a power converter, illustrated in accordance with some embodiments of the present disclosure.

FIG. 7 is a timing diagram of controlling a power converter, illustrated in accordance with some embodiments of the present disclosure.

FIG. 8A is a circuit diagram of a power converter, illustrated in accordance with some embodiments of the present disclosure.

FIG. 8B is a circuit diagram of a power converter, illustrated in accordance with some embodiments of the present disclosure.

FIG. 8C is a circuit diagram of a power converter, illustrated in accordance with some embodiments of the present disclosure.

FIG. 8D is a circuit diagram of a power converter, illustrated in accordance with some embodiments of the present disclosure.

FIG. 8E is a circuit diagram of a power converter, illustrated in accordance with some embodiments of the present disclosure.

FIG. 8F is a circuit diagram of a power converter, illustrated in accordance with some embodiments of the present disclosure.

FIG. 9 is a circuit diagram of a power converter, illustrated in accordance with some embodiments of the present disclosure.

FIG. 10 is a timing diagram of controlling a power converter, illustrated in accordance with some embodiments of the present disclosure.

FIG. 11A is a circuit diagram of a power converter, illustrated in accordance with some embodiments of the present disclosure.

FIG. 11B is a circuit diagram of a power converter, illustrated in accordance with some embodiments of the present disclosure.

FIG. 11C is a circuit diagram of a power converter, illustrated in accordance with some embodiments of the present disclosure.

FIG. 11D is a circuit diagram of a power converter, illustrated in accordance with some embodiments of the present disclosure.

### DETAILED DESCRIPTION

In the present disclosure, when an element is referred to as “connected” or “coupled”, it may mean “electrically connected” or “electrically coupled”. “Connected” or “coupled” can also be used to indicate that two or more components operate or interact with each other. In addition, although the terms “first”, “second”, and the like are used in the present disclosure to describe different elements, the terms are used only to distinguish the elements or operations described in the same technical terms. The use of the term is not intended to be a limitation of the present disclosure.

Unless otherwise defined, all terms (including technical and scientific terms) used in the present disclosure have the same meaning as commonly understood by the ordinary skilled person to which the concept of the present invention belongs. It will be further understood that terms (such as those defined in commonly used dictionaries) should be interpreted as having a meaning consistent with its meaning in the related technology and/or the context of this specification and not it should be interpreted in an idealized or overly formal sense, unless it is clearly defined as such in this article.

The terms used in the present disclosure are only used for the purpose of describing specific embodiments and are not intended to limit the embodiments. As used in the present disclosure, the singular forms “a”, “one” and “the” are also intended to include plural forms, unless the context clearly indicates otherwise. It will be further understood that when used in this specification, the terms “comprises (comprising)” and/or “includes (including)” designate the existence of stated features, steps, operations, elements and/or components, but the existence or addition of one or more other features, steps, operations, elements, components, and/or groups thereof are not excluded.

Hereinafter multiple embodiments of the present disclosure will be disclosed with schema, as clearly stated, the details in many practices it will be explained in the following description. It should be appreciated, however, that the details in these practices is not applied to limit the present disclosure. Also, it is to say, in some embodiments of the present disclosure, the details in these practices are non-essential. In addition, for the sake of simplifying schema, some known usual structures and element in the drawings by a manner of simply illustrating for it.

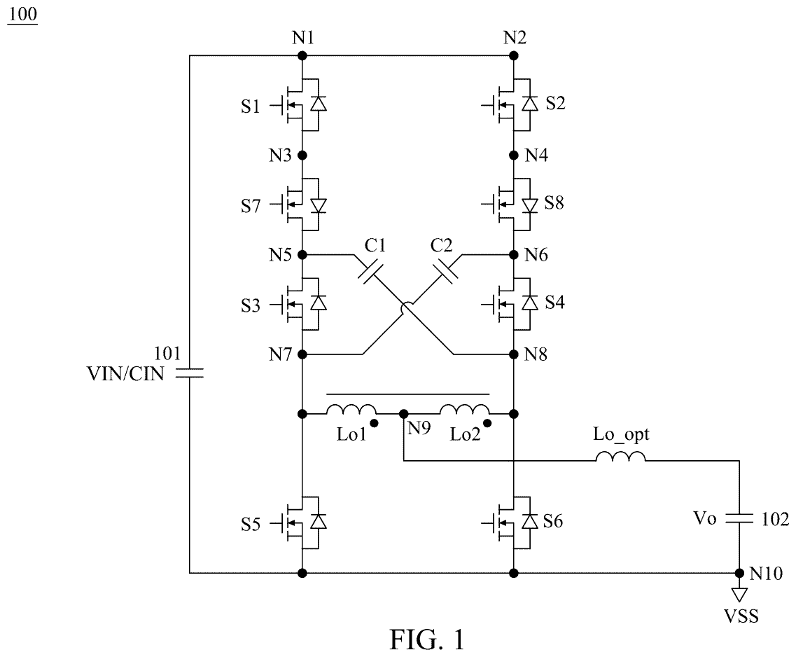

FIG. 1 is a circuit diagram of a power converter 100, illustrated in accordance with some embodiments of the present disclosure. As illustratively shown in FIG. 1, the power converter 100 includes an input power source 101, a load 102, capacitors C1 and C2, inductors Lo1, Lo2, and Lo_opt, and multiple switches S1-S8. Wherein, the input power source 101 includes an input capacitor CIN.

In some embodiments, the input power source 101 is configured to provide an input voltage signal VIN. The power converter 100 is configured to provide an output voltage Vo to the load 102 according to the input voltage signal VIN. In some embodiments, the switches S1-S8 can be turned on and turned off according to multiple signals Vgs_S1-Vgs_S8 generated by a controller (not shown).

As shown in FIG. 1, a first terminal of the switch S1 is coupled to the input power source 101 at a node N1, and is configured to receive the input voltage signal VIN. A second terminal of the switch S1 is coupled to a second terminal of the switch S7 at a node N3, and a first terminal of the switch S7 is coupled to a nodeN5. A terminal of the capacitor C1 is coupled to the switch S7 at the node N5, another terminal of the capacitor C1 is coupled to the switch S4 at the N8. A first terminal of the switch S2 is coupled to the input power source 101 at a node N2, and is configured to receive the input voltage signal VIN. A second terminal of the switch S2 is coupled to a second terminal of the switch S8 at a node N4, and a first terminal of the switch S8 is coupled to a node N6. A terminal of the capacitor C2 is coupled to the switch S8 at a node N6, another terminal of the capacitor C2 is coupled to the switch S3 at a node N7. A first terminal of the switch S3 is coupled to the switch S7 at the node N5, a second terminal of the switch S3 is coupled to the node N7. A first terminal of the switch S4 is coupled to the switch S8 at the node N6, a second terminal of the switch S4 is coupled to the node N8.

In some embodiments, a terminal of the inductor Lo1 is coupled to the switch S3 at the node N7, and another terminal of the inductor Lo1 is coupled to a node N9. A terminal of the inductor Lo2 is coupled to the switch S4 at the node N8, and another terminal of the inductor Lo2 is coupled to the node N9. A terminal of the load 102 is coupled to the inductor Lo1 and Lo2 at the node N9, another terminal of the load 102 is coupled to a node N10, and the node N10 is configured to receive a reference voltage signal VSS. A first terminal of the switch S5 is coupled to the inductor Lo1 at the node N7, a second terminal of the switch S5 is coupled to the node N10. A first terminal of the switch S6 is coupled to the inductor Lo2 at the node N8, a second terminal of the switch S6 is coupled to the node N10. Another terminal of the node N10 is coupled to the input power source 101 and forms a loop. In some embodiments, the switches S5 and S6 is configured to perform a synchronous rectification in the power converter 100.

In some embodiments, the reference voltage signal VSS has a ground voltage level. In some embodiments, the input voltage signal VIN has a voltage level VINL.

In some embodiments, the inductors Lo1, Lo2, and Lo_opt are configured to serve as the rectifying inductors when the synchronous rectification is performed in the power converter 100. The inductor Lo_opt can be selectively included in the power converter 100 and power converters 400, 600, and 900 discussed in following paragraphs of the present disclosure. Specifically, a terminal of the inductor Lo_opt can be coupled between the inductors Lo1 and Lo2, another terminal of the inductor Lo_opt is coupled to the load 102.

In some embodiments, the inductors Lo1 and Lo2 in the power converter 100 are back-coupling connected. When the inductors Lo1 and Lo2 are totally back-coupling connected, the inductor Lo_opt coupled between the inductors Lo1 and Lo2 is required to be added into the power converter 100 and serves as a rectifying inductor. When the inductors Lo1 and Lo2 are partially back-coupling connected, the inductor Lo_opt is not required to be added into the power converter 100, and the power converter 100 can use a leakage inductance of the inductors Lo1 and Lo2 as the rectifying inductance. The partially back-coupling connected of the inductors Lo1 and Lo2 is discussed hereafter to illustrate the embodiments of the present disclosure.

In some embodiments, when the inductors Lo1 and Lo2 are partially back-coupling connected, the inductors Lo1 and Lo2 have a coupling coefficient K. Wherein, a value of the coupling coefficient K is between 0 and −1.

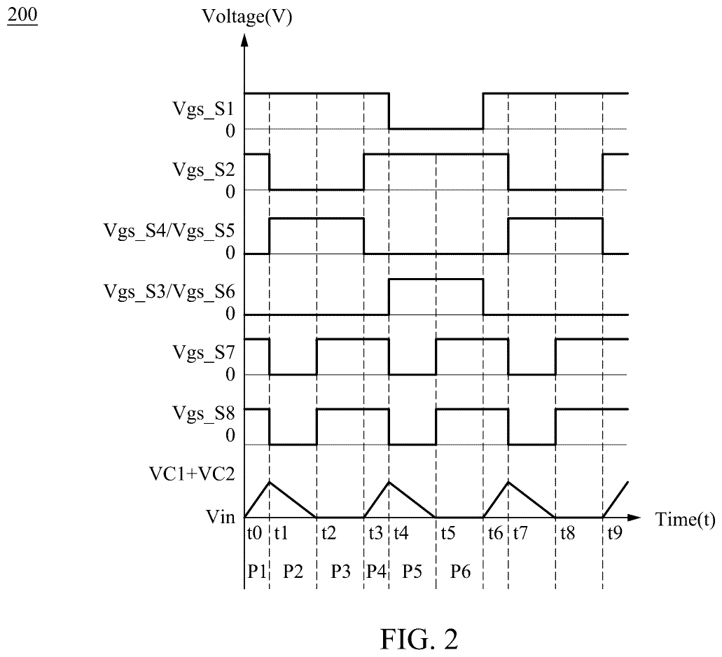

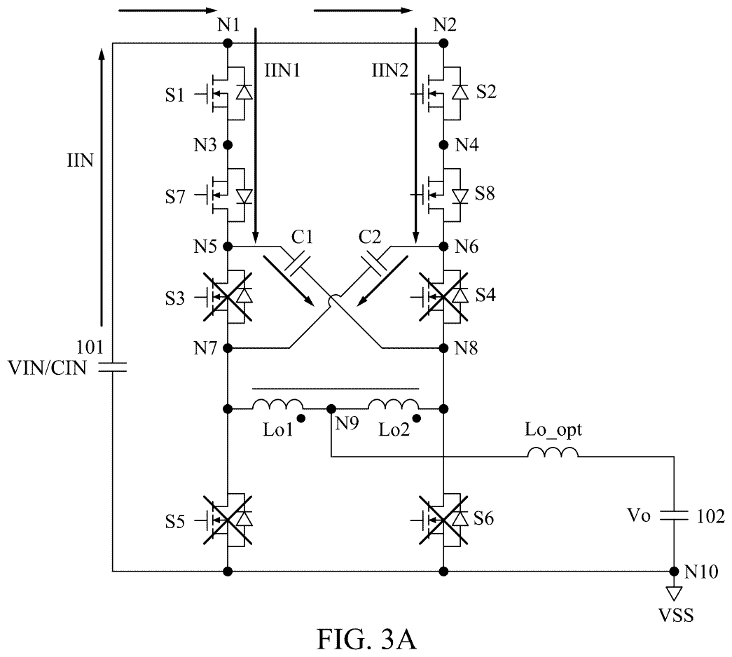

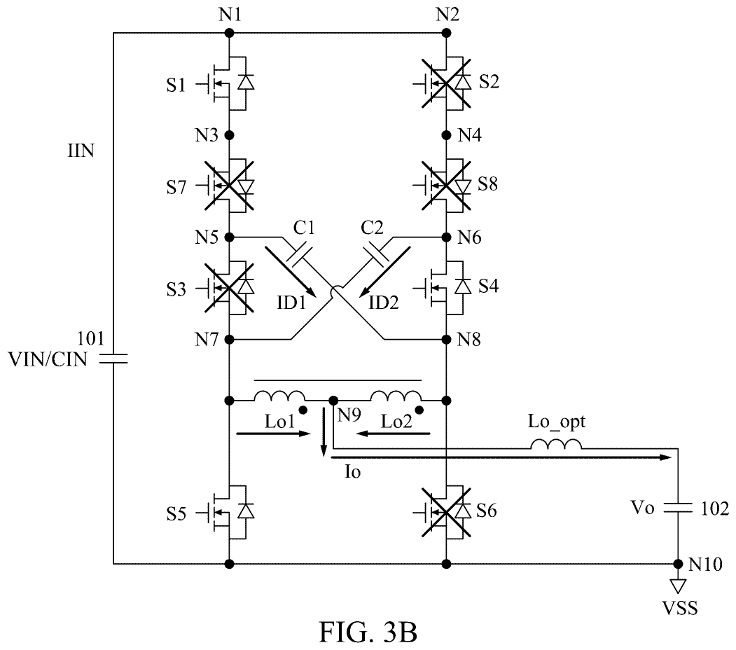

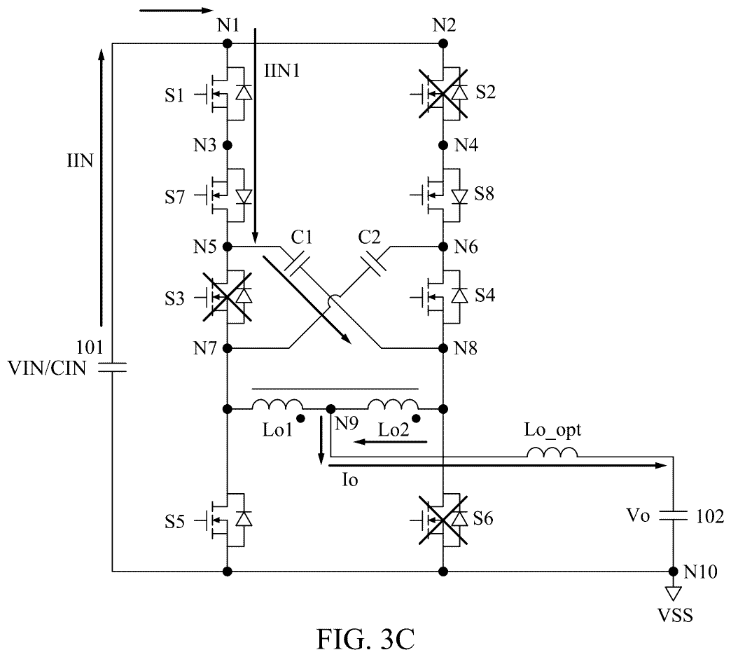

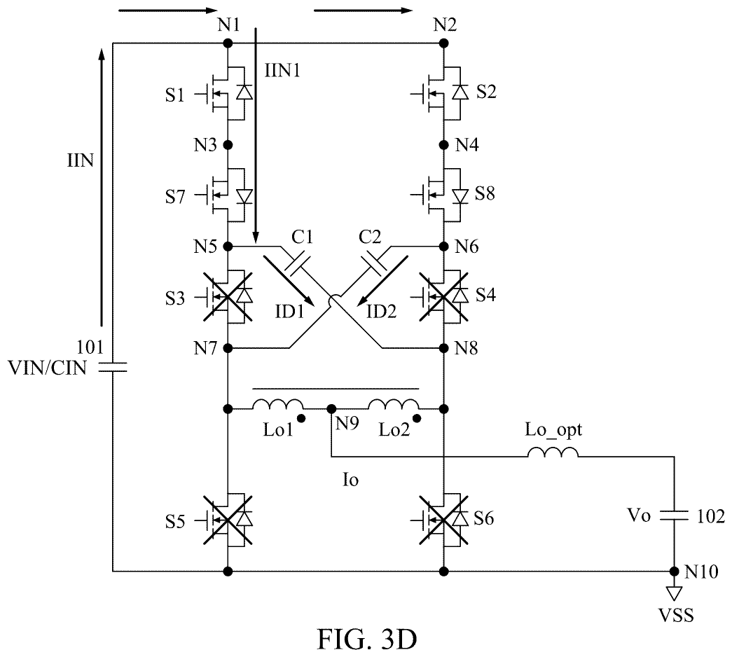

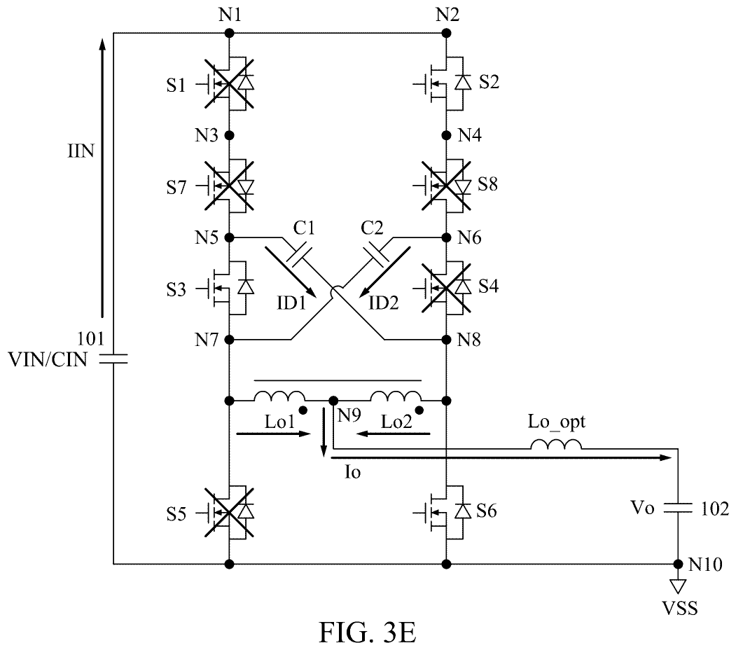

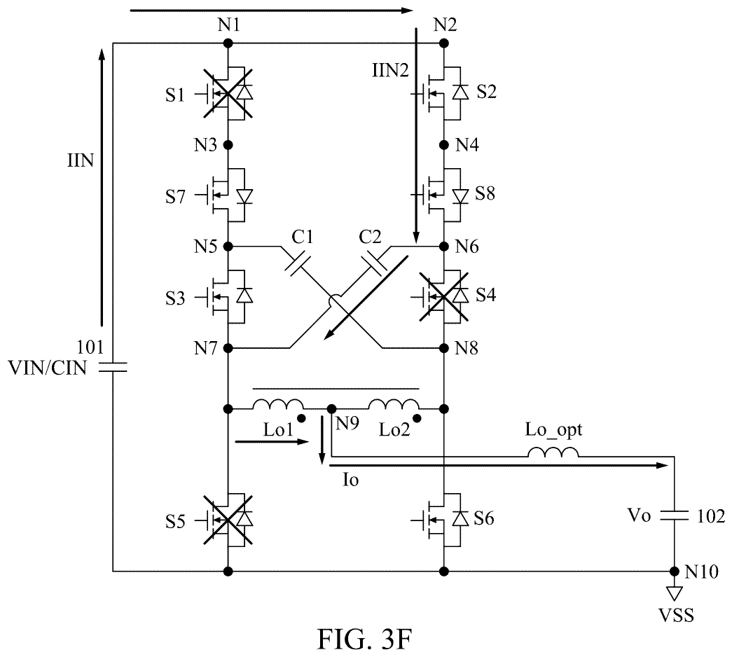

In some embodiments, when the power converter 100 is operating, the input power source 101 is configured to impose the input voltage signal VIN to the switches S1 and S2, and respectively generate input current signals IIN1 and IIN2. The input current signal IIN1 flows from the switch S7 through the capacitor C1 to the inductor Lo2, and generate a voltage signal VC1 at the two terminals of the capacitor C1. The input current signal IIN2 flows from the switch S8 through the capacitor C2 to the inductor Lo1, and generate a voltage signal VC2 at the two terminals of the capacitor C2. In response to the input current signal IIN1 and the input current signal IIN2 respectively flowing to the inductor Lo1 and Lo2, the input current signal IIN1 and IIN2 generate an output current signal Io at the node N9. The output current signal Io flows from the node N9 to the load 102 to provide power to the load 102. Further details regarding the operation of the power converter 100 are discussed in FIG. 2, FIG. 3A to FIG. 3F and corresponding paragraphs of the present disclosure.

In some embodiments, the switches S1-S8 can be implemented by Metal Oxide Semiconductor Field-Effect Transistor (MOSFET). In the embodiments of the present disclosure, the switch S1-S8 is implemented by an N-type MOSFET. Wherein, each of the first terminals of the switches S1-S8 corresponds to a drain terminal and each of the second terminals of the switches S1-S8 corresponds to a source terminal.

In some embodiments, the output current signal Io includes, when the power converter 100 is operating, an induced current signal and an exciting current signal generated by an electromagnetic induction of the inductors Lo1 and Lo2.

In some approaches, a high-power voltage converter having high power-converting efficiency can be applied in circumstances when the voltage level of the input voltage signal of the bus is four times higher than the voltage level of the output voltage signal. At this moment, two switches in the converter have ratios of turned-on period being lower than or equal to 0.5, respectively. The ratios can be referred to as duty ratios. When the voltage level of the input voltage signal of the bus is four times lower than the voltage level of the output voltage signal, the duty ratio is higher than 0.5, and the circuit occurs periodic reverse current inrushes imposed on the switches and causing damage of the converter.

In the embodiments of the present disclosure, compared to other approaches, the power converter 100 is further arranged with the switches S7 and S8 respectively connected in series to the switch S1 and S2. The power converter 100 having the switches S7 and S8 can depress voltage signals VC1 and VC2 of the capacitors C1 and C2 by controlling the turn on and turn off of the switches S7 and S8, and the conducting direction of body diodes of the switches S7 and S8, such that the voltage signals VC1 and VC2 are effectively decreased. As a result, in the circumstance that the voltage level of the input voltage signal VIN is four times lower than the voltage level of the output voltage signal V0, the power converter 100 of the present disclosure can effectively achieve the purpose of lowering the voltage level of the capacitor and further depressing the reverse current inrush generated by the voltage of the capacitor.

FIG. 2 is a timing diagram 200 of controlling the power converter 100, illustrated in accordance with some embodiments of the present disclosure. As illustratively shown in FIG. 2, the timing diagram 200 illustrates the operation of the power converter 100 during a period between times T0 to time T9.

Referring to FIG. 1 and FIG. 2, the timing diagram 200 illustrates the change of signals Vgs_S1-Vgs_S8, and a voltage level VC12 of a sum of the voltage level of the voltage signal VC1 and the voltage level of the voltage signal VC2 with respect to time.

FIG. 3A to FIG. 3F are circuit diagrams of the power converter 100 operated in different periods of time, illustrated in accordance with some embodiments of the present disclosure. FIG. 3A corresponds to a period P1 between times T0 and T1. FIG. 3B corresponds to a period P2 between times T1 and T2. FIG. 3C corresponds to a period P3 between times T2 and T3. FIG. 3D corresponds to a period P4 between times T3 and T4. FIG. 3E corresponds to a period P5 between times T4 and T5. FIG. 3F corresponds to a period P6 between times T5 and T6. Wherein, a period between times T6 and T7, a period between times T7 and T8, and a period between times T8 and T9 can be respectively referred to FIG. 3A to FIG. 3C.

In some embodiments, a period between FIG. 3A to FIG. 3C and the corresponding periods P1-P3 is a duty cycle of the switch S1. A period between FIG. 3D to FIG. 3F and the corresponding periods P4-P6 is a duty cycle of the switch S2.

Referring to FIG. 2 and FIG. 3A, during the period P1, each of the signals Vgs_S1, Vgs_S2, Vgs_S7 and Vgs_S8 has a turning on voltage level V1, such that each of the switches S1, S2, S7 and S8 remains turned on. Each of the signals Vgs_S3, Vgs_S4, Vgs_S5 and Vgs_S6 has a turning off voltage level V0, such that each of the switch S3, S4, S5 and S6 remains turned off. In some embodiments, the turning off voltage level V0 has a voltage level of 0 volt.

During the period P1, the input power source 101 provides the input voltage signal VIN to the first terminal of the switch S1 and the first terminal of the switch S2, such that the nodes N1 and N2 has the voltage level VINL being the same as the input voltage signal VIN. The input current signal IIN1 flows from the input power source 101 through the switch S1, then from the second terminal of the switch S7 flows into the switch S7. The input current signal IIN1 further flows through the switch S7 to the capacitor C1 to charge the capacitor C1. The input current signal IIN2 flows from the input power source 101 through the switch S2, then from the second terminal of the switch S8 flows into the switch S8. The input current signal IIN1 further flows through the switch S8 to the capacitor C2 to charge the capacitor C2.

At this moment, in response to the input current signals IIN1 and IIN2 respectively charging the capacitors C1 and C2, each of the voltage signals VC1 and VC2 keeps increasing. The sum of each of the voltage level of the voltage signal VC1 and the voltage level of the voltage signal VC2 has the voltage level VC12, and the voltage level VC12 is higher than the voltage level VINL.

At time T1, each of the signals Vgs_S2, Vgs_S7 and Vgs_S8 is switched to the voltage level V0, such that each of the switches S2, S7 and S8 is turned off. When each of the switches S2, S7 and S8 has been turned off, each of the signals Vgs_S4 and Vgs_S5 is switched to the voltage level V1, such that each of the switches S4 and S5 is turned on.

In some embodiments, during a period between each of the switches S2, S7 and S8 being turned off to each of the switches S4 and S5 being turned on has an operating dead zone. Alternatively stated, when each of the switches S2, S7 and S8 is turned off, each of the switches S4 and S5 remains turned off, such that the power converter 100 breaks into an open circuit. Then, when each of the switches S2, S7 and S8 has been turned off, each of the switches S4 and S5 is turned on, such that the power converter 100 continues to operate.

In some circumstances, when the voltage level VC12 is higher than the voltage level VINL, and when the switch S3 is turned on, the voltage signals VC1 and VC2 generate a reverse current signal IREV. When the voltage level VC12 is higher than the voltage level VINL, and the switches S7 and S8 remain turned on, that is when the switches S7 and S8 are not implemented in the power converter 100, the reverse current signal IREV flows from a body diode of the switch S2 to the input power source 101. In some other circumstances, when the voltage level VC12 is higher than the voltage level VINL, and when the switch S4 is turned on, the voltage signals VC1 and VC2 generate the reverse current signal IREV. When the voltage level VC12 is higher than the voltage level VINL, and the switches S7 and S8 remain turned on, that is, when the switches S7 and S8 are not implemented in the power converter 100, the reverse current signal IREV flows from a body diode of the switch S1 to the input power source 101. As a result, the reverse current signal IREV generates a reverse current inrush to the input power source 101, causing damage to the power converter. In some embodiments of the present disclosure, the power converter 100 can block the reverse current signal IREV which flows to the input power source 101 generating the reverse current inrush by turning off the switches S7 and S8.

Referring to FIG. 2 and FIG. 3B, during the period P2, each of the signals Vgs_S1, Vgs_S4 and Vgs_S5 has the turning on voltage level V1, such that each of the switches S1, S4 and S5 remains turned on. Each of the signals Vgs_S2, Vgs_S3, Vgs_S6, Vgs_S7 and Vgs_S8 has the turning off voltage level V0, such that each of the switches S2, S3, S6, S7 and S8 remains turned off.

During the period P2, the voltage signal VC1 remains unchanged, and the charged capacitor C2 generated a current signal ID2. The current signal ID2 flows from the capacitor C2 through the switch S4, the node N8, and the inductor Lo2 to the node N9, and generate the output current signal Io at the node N9 to provide power to the load 102. Then, the current signal ID2 flows from the load 102 through the switch S5 and the node N7 to the capacitor C2 to form a loop. In some embodiments, since the inductors Lo2 and Lo1 are back-coupling connected, when the current signal flows through the inductor Lo2, the inductor Lo1 generates an induced current signal to provide power to the load 102. After the induced current of the inductor Lo1 flowed through the load 102, the induced current flows to the switch S5 to form a loop.

At this moment, in response to the current signal ID2 generating the output current signal Io at the node N9 to discharge to the load 102, the voltage level of voltage signal VC2 keeps decreasing and the voltage level VC12 decreases correspondingly.

Then, at time T2, the voltage level VC12 decreases to the voltage level VINL. When the voltage level VC12 has decreased to the voltage level VINL, each of the signals Vgs_S7 and Vgs_S8 switches from the voltage level V0 to the voltage level V1, such that each of the switches S7 and S8 is turned on.

Referring to FIG. 2 and FIG. 3C, during the period P3, each of the signals Vgs_S1, Vgs_S4, Vgs_S5, Vgs_S7 and Vgs_S8 has the turning on voltage level V1, such that each of the switch S1, S4, S5, S7 and S8 remains turned on. Each of the signals Vgs_S2, Vgs_S3 and Vgs_S6 has the turning off voltage level V0, such that each of the switch S2, S3 and S6 remains turned off.

During the period P3, the voltage level VC12 is the same as the voltage level VINL. The input current signal IIN1 flows from the input power source 101 subsequently through the switch S1, the switch S7 and the capacitor C1 to the node N8, and flows from the node N8 through the inductor Lo2 to the node N9, and generates the output current signal Io at the node N9 to provide power to the load 102. In response to the input current signal IIN1 generating the output current signal Io to provide power to the load 102, the voltage signal VC1 keeps increasing. Then, the charged capacitor C2 discharges to generate the current signal ID2. The current signal ID2 flows from the capacitor C2 through the switch S4, the node N8, and the inductor Lo2 generating the output current signal Io to provide power to the load 102, and flows from the load 102 through the switch S5, the node N7 to the capacitor C2 to form a loop. In response to the capacitor C2 discharging, the voltage signal VC2 keeps decreasing. In the meantime, the induced current generated by the inductor Lo1 provides power to the load 102. After the induced current of the inductor Lo1 flowed through the load 102, the induced current flows to the switch S5 to form a loop. At this moment, the voltage signal VC1 keeps increasing, and the voltage signal VC2 keeps, the voltage level VC12 remains the same as the voltage level of the input voltage signal VIN.

In some embodiments, the output current signal Io generated at the node N9 includes the input current signal IIN1 flowing from the inductor Lo2 to the node N9, the current signal ID2 flowing through the node N8 and the inductor Lo2, and the current signal ID2 continuously flowing from the inductor Lo1.

Then, at time T3, each of the signals Vgs_S4 and Vgs_S5 switches to the voltage level V0, such that each of the switch S4 and S5 is turned off. The signals Vgs_S2 switches to the voltage level V1, such that the switch S2 is turned on. At this moment, the power converter 100 completes a duty cycle of the switch S1 in a period between times T0 to time T3.

In some embodiments, the operation of the power converter 100 in FIG. 3D to FIG. 3F and during the period between time T3 to time T6 is similar to the operation in FIG. 3A to FIG. 3C and the period between time T0 to time T3. The similar parts of the operation are not repeated herein for simplicity.

Referring to FIG. 2 and FIG. 3D, during the period P4, each of the signals Vgs_S1, Vgs_S2, Vgs_S7 and Vgs_S8 has the turning on voltage level V1, such that each of the switches S1, S2, S7 and S8 remains turned on. Each of the signals Vgs_S3, Vgs_S4, Vgs_S5 and, Vgs_S6 has the turning off voltage level V0, such that each of the switches S3, S4, S5 and S6 remains turned off.

During the period P4, in response to each of the switches S7 and S8 being turned on, the input current signals IIN1 and IIN2 charge the capacitors C1 and C2, respectively.

At time T4, each of the signals Vgs_S1, Vgs_S7 and Vgs_S8 switches to the voltage level V0, such that each of the switches S1, S7 and S8 is turned off. When each of the switches S1, S7 and S8 has been turned off, each of the signals Vgs_S3 and Vgs_S6 switches to the voltage level V1, such that each of the switches S3 and S6 is turned on.

Referring to FIG. 2 and FIG. 3E, during the period P5, each of the signals Vgs_S2, Vgs_S3 and Vgs_S6 has the turning on voltage level V1, such that each of the switches S2, S3 and S6 remains turned on. Each of the signals Vgs_S1, Vgs_S4, Vgs_S5, Vgs_S7, and Vgs_S8 has the turning off voltage level V0, such that each of the switches S1, S4, S5, S7, and S8 remains turned off.

During the period P5, the voltage signal VC2 remains unchanged, and the charged capacitor C1 generates the current signal ID1. The current signal ID1 flows from the capacitor C1 through the switch S3, the node N7, and the inductor Lo1 to the node N9, and generates the output current signal Io at the node N9 to provide power to the load 102. Then, the current signal ID1 flows from the load 102 through the switch S6, the node N8 to the capacitor C1 to form a loop. In some embodiments, since the inductors Lo2 and Lo1 are back-coupling connected, when the current signal flows through the inductor Lo1, the inductor Lo2 generates the induced current to provide power to the load 102. After the induced current of the inductor Lo2 flowed through the load 102, the induced current flows to the switch S6 to form a loop.

At this moment, in response to the current signal ID1 generating the output current signal Io at the node N9 to discharge to the load 102, the voltage signal VC1 keeps decreasing, and the voltage level VC12 is correspondingly decreased.

Then, at time T2, the voltage level VC12 decreases to the voltage level VINL. When the voltage level VC12 has decreased to the voltage level VINL, each of the signals Vgs_S7 and Vgs_S8 switches from the voltage level V0 to the voltage level V1, such that each of the switches S7 and S8 is turned on.

Referring to FIG. 2 and FIG. 3F, during the period P6, each of the signals Vgs_S2, Vgs_S3, Vgs_S6, Vgs_S7, and Vgs_S8 has the turning on voltage level V1, such that each of the switches S1, S3, S6, S7, and S8 remains turned on. Each of the signals Vgs_S1, Vgs_S4, and Vgs_S5 has the turning off voltage level V0, such that each of the switches S1, S4 and S5 remains turned off.

During the period P6, the voltage level VC12 is the same as the voltage level VINL. The input current signal IIN2 flows from the input power source 101 and subsequently through the switch S2, the switch S8, and the capacitor C2 to the node N7, and flows from the node N7 through the inductor Lo1 to the node N9, and generate the output current signal Io at the node N9 to provide power to the load 102. In response to the input current signal IIN2 generating the output current signal Io to provide power to the load 102, the voltage signal VC2 keeps increasing. Then, the charged capacitor C1 discharges to generate the current signal ID1. The current signal ID1 flows from the capacitor C1 through the switch S3, the node N7, and the inductor Lo1, generating the output current signal Io to provide power to the load 102, and flows from the load 102 through the switch S6 and the node N8 to the capacitor C1 to form a loop. In response to the capacitor C1 discharging, the voltage signal VC1 keeps decreasing. In the meantime, the induced current of the inductor Lo2 provides power to the load 102. After the induced current of the inductor Lo1 flowed through the load 102, the induced current flows to the switch S6 to form a loop. At this moment, the voltage signal VC2 keeps increasing, and the voltage signal VC1 keeps decreasing, the voltage level VC12 remains the same as the voltage level of the input voltage signal VIN.

In some embodiments, the output current signal Io generated at the node N9 includes the input current signal IIN2 that flows from the inductor Lo1 to the node N9, the current signal ID1 that flows through the node N7 and the inductor Lo1, and the current signal ID1 that continuously flows from the inductor Lo2.

At time T6, each of the signals Vgs_S3 and Vgs_S6 switches to the voltage level V0, such that each of the switches S3 and S6 is turned off. The signal Vgs_S1 switches to the voltage level V1, such that the switch S1 is turned on. At this moment, the power converter 100 completes a duty cycle of the switch S2 in a period between times T3 to T6.

In some embodiments, when the power converter 100 has completed the duty cycles of the switches S1 and S2, the power converter 100 subsequently repeats the next duty cycle of the switches S1 and S2. Alternatively stated, when the power converter 100 has completed the duty cycles of the switches S1 and S2, the power converter 100 performs the operation of a period between time T6 to time T9. The period between time T6 to time T9 corresponds to the operation of the power converter 100 during the periods P1-P3 shown in FIG. 3A to FIG. 3C. In some embodiments, the operation of the power converter 100 after time T9 can be extended to multiple operations similar to the period between times T0 and T9, but the present disclosure is not limited to the operation between time T0 to time T9.

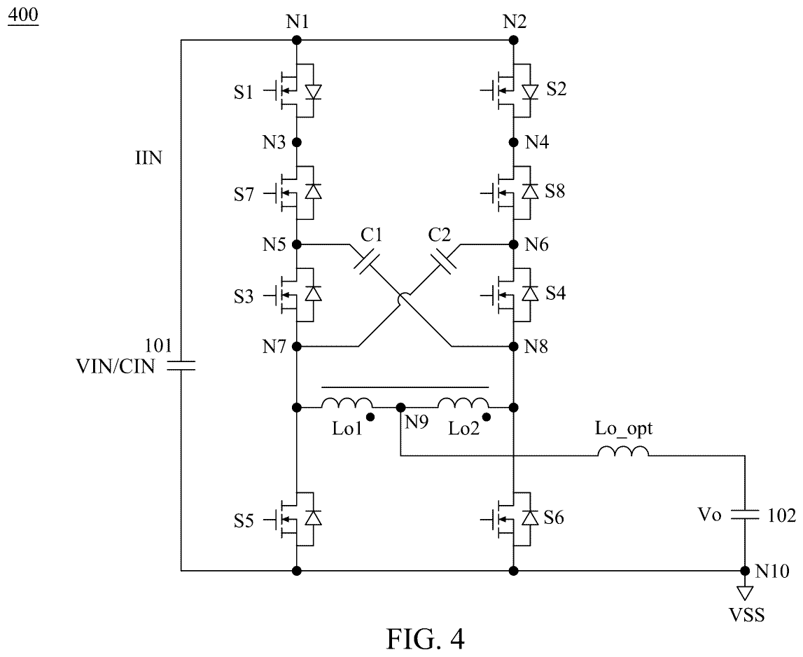

FIG. 4 is a circuit diagram of a power converter 400, illustrated in accordance with some embodiments of the present disclosure. The power converter 400 is another embodiment of the power converter 100 shown in FIG. 1. As shown in FIG. 4, the power converter 400 includes the input power source 101, the load 102, the capacitors C1 and C2, the inductors Lo1, Lo2, and Lo_opt, and the switches S1-S8. Wherein, the input power source 101 includes an input capacitor CIN. Wherein, when the inductors Lo1 and Lo2 are totally back-coupling connected, a terminal of the inductor Lo_opt is coupled between the inductors Lo1 and Lo2, the other terminal of the inductor Lo_opt is coupled to the load 102. When the inductors Lo1 and Lo2 are partially back-coupling connected, the inductor Lo_opt can be selectively neglected in the power converter 400.

In some embodiments, the coupling relationship in the power converter 400 is similar to the power converter 100 shown in FIG. 1, and the similarities are not repeated herein for simplicity. Referring to FIG. 4 and FIG. 1, the difference of the power converter 400 compared to the power converter 100 is that the location of the switches S7 and S8 and the location of the switches S1 and S2.

Specifically, as shown in FIG. 4, a second terminal of the switch S7 is coupled to the input power source 101 at the node N1, and is configured to receive the input voltage signal VIN. The first terminal of the switch S7 is coupled to the first terminal of the switch S1 at the node N3, and the second terminal of the switch S1 is coupled to the capacitor C1 at the node N5. The second terminal of the switch S8 is coupled to the input power source 101 at the node N2, and is configured to receive the input voltage signal VIN. The first terminal of the switch S8 is coupled to the first terminal of the switch S2 at the node N4, and the second terminal of the switch S2 is coupled to the capacitor C2 at the node N6.

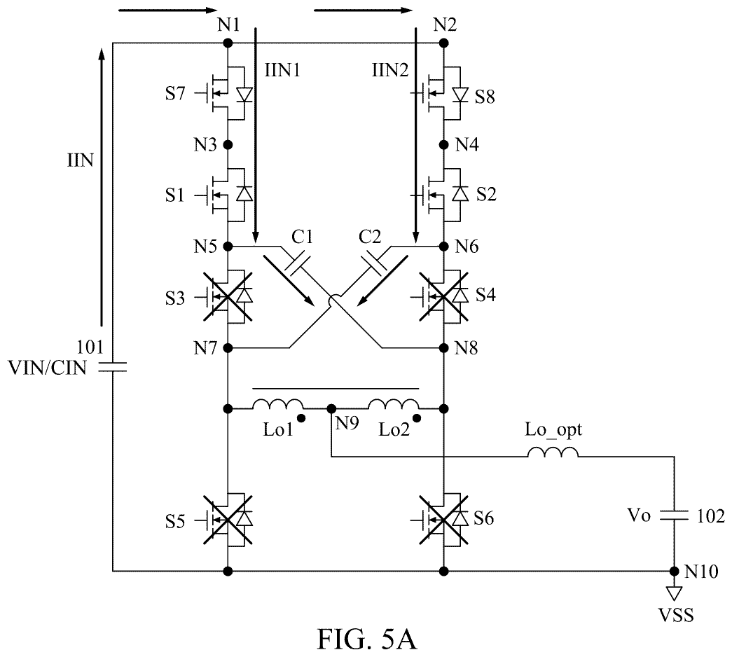

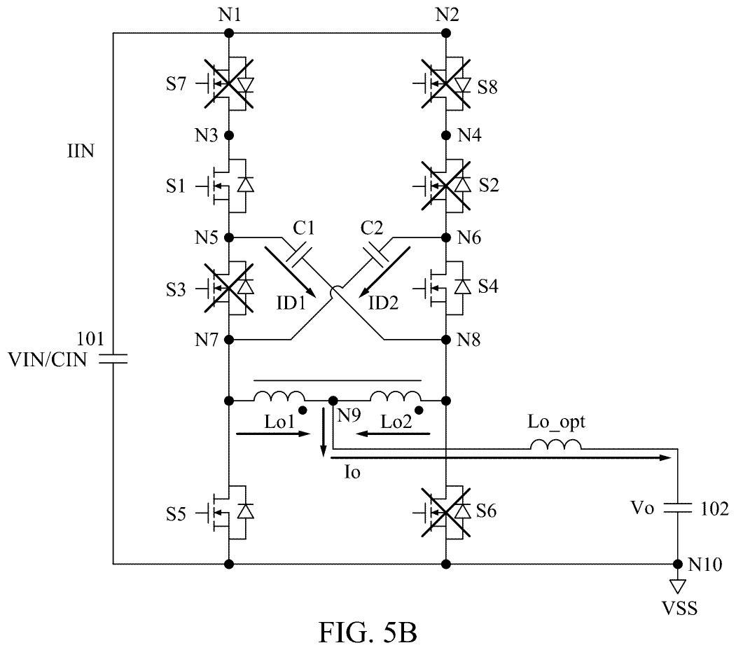

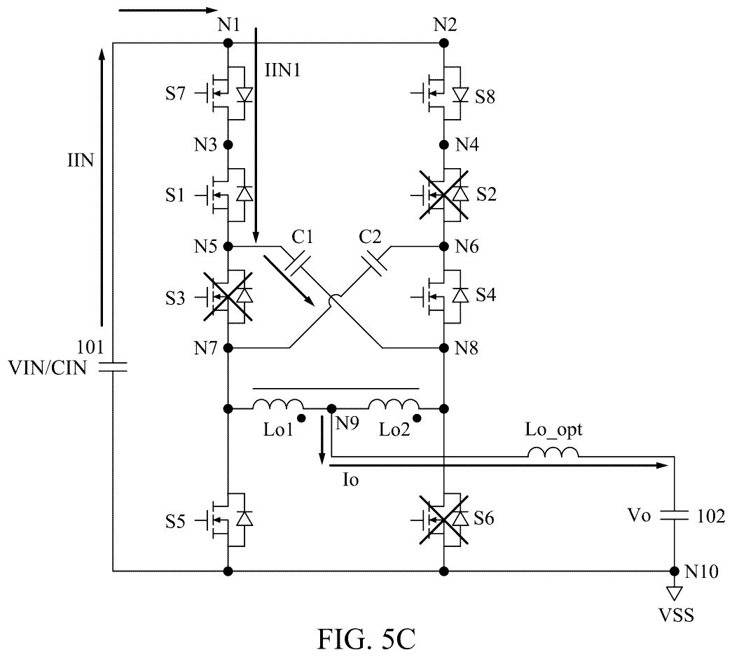

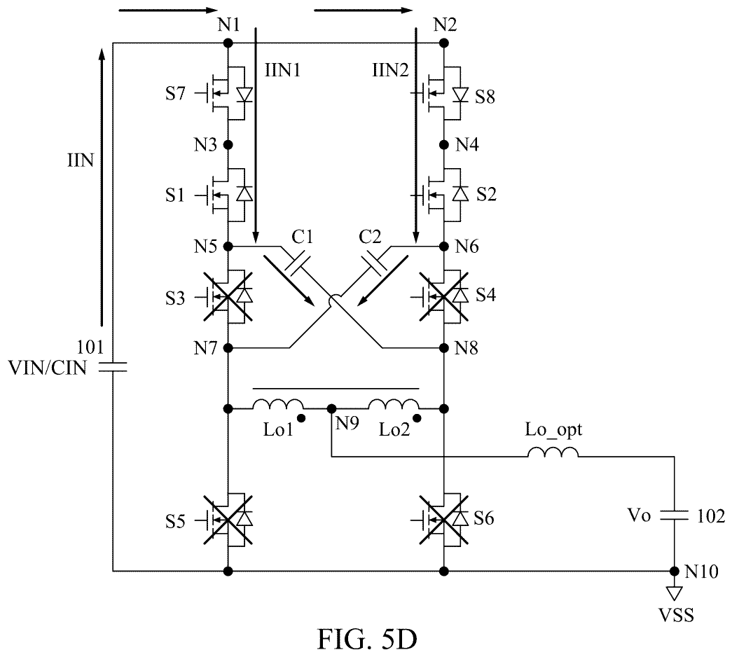

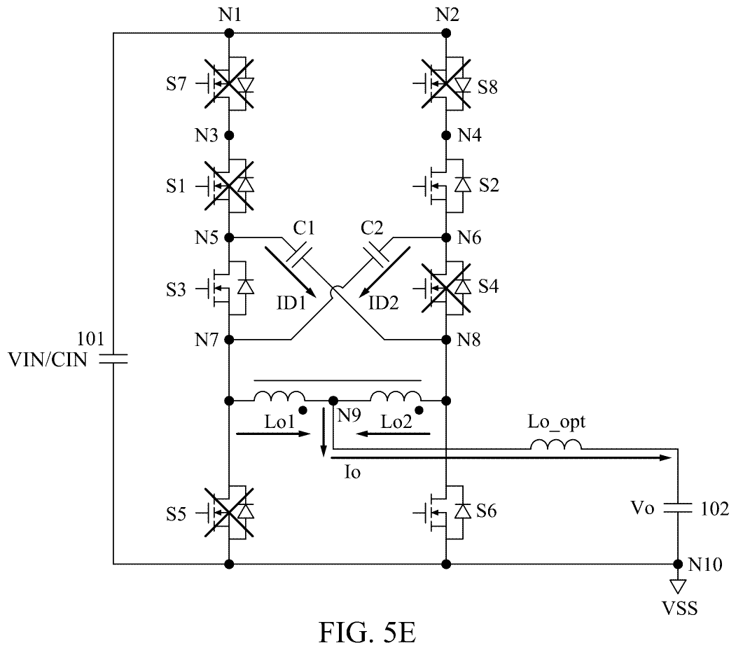

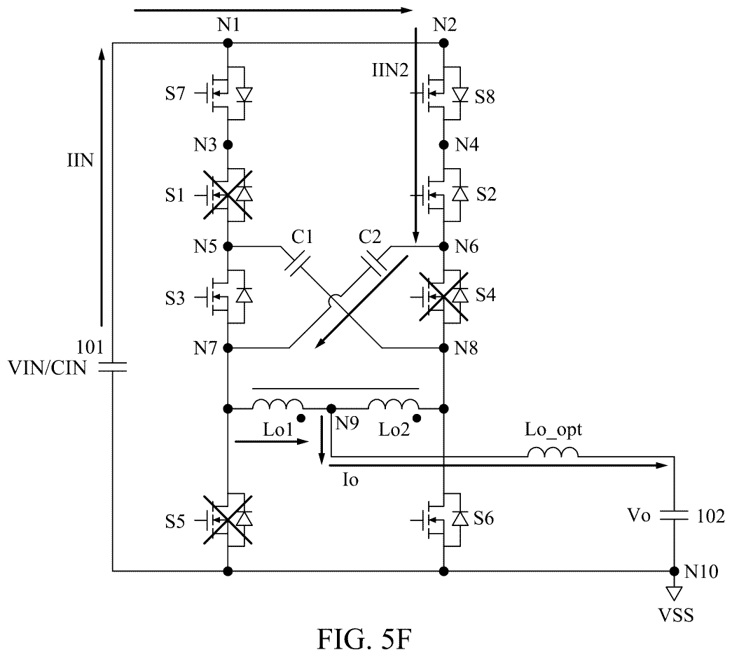

In some embodiments, when the power converter 400 is operating, the input power source 101 is configured to impose the input voltage signal VIN to the switches S7 and S8, and generate the input current signals IIN1 and IIN2, respectively. The input current signal IIN1 flows from the switch S1 through the capacitor C1 to the inductor Lo2, and generate the voltage signal VC1 at two terminals of the capacitor C1. The input current signal IIN2 flows from the switch S2 through the capacitor C2 to the inductor Lo1, and generate the voltage signal VC2 at two terminals of the capacitor C2. In response to the input current signal IIN1 and the input current signal IIN2 respectively flowing to the inductor Lo1 and Lo2, the input current signals IIN1 and IIN2 generate the output current signal Io at the node N9. The output current signal Io flows from the node N9 to the load 102 to provide power to the load 102. Further details regarding the operation of the power converter 400 are discussed in FIG. 5A to FIG. 5F and corresponding paragraphs of the present disclosure.

In some embodiments of the present disclosure, the power converter 400 is similar to the power converter 100. The power converter 400 is further implemented with the switches S7 and S8 that are connected in series to the switches S1 and S2, respectively. The power converter 400 having the switches S7 and S8 can depress the voltage signals VC1 and VC2 of the capacitors C1 and C2, such that voltage levels of the voltage signals VC1 and VC2 can be effectively decreased. In the circumstance that the voltage level VINL is four times lower than the voltage level of the voltage signal Vo, the power converter 400 can also achieve the purpose of lowering the voltage of the capacitor, and further depress the reverse current inrush generated by the voltage of the capacitor.

Referring to FIG. 4 and FIG. 2, in some embodiments, the timing diagram 200 also illustrates the changes of the signals Vgs_S1-Vgs_S8, and the voltage level VC12 of a sum of the voltage level of the voltage signal VC1 and the voltage level of the voltage signal VC2 with respect to time. The timing diagram 200 shown in FIG. 2 is adopted herein to illustrate the operation of the power converter 400 in a period between times T0 to time T9.

FIG. 5A to FIG. 5F are circuit diagrams of the power converter 400 operated in different periods of time, illustrated in accordance with some embodiments of the present disclosure. FIG. 5A corresponds to the period P1. FIG. 5B corresponds to the period P2. FIG. 5C corresponds to the period P3. FIG. 5D corresponds to the period P4. FIG. 5E corresponds to the period P5. FIG. 5F corresponds to the period P6. Wherein, a period between times T6 and T7, a period between times T7 and T8, and a period between times T8 and T9 can be referred to FIG. 5A to FIG. 5C, respectively.

In some embodiments, FIG. 5A to FIG. 5C and the corresponding periods P1-P3 are a duty cycle of the switch S1. FIG. 5D to FIG. 5F and the corresponding periods P4-P6 are a duty cycle of the switch S2.

Referring to FIG. 2 and FIG. 5A, during the period P1, each of the signals Vgs_S1, Vgs_S2, Vgs_S7, and Vgs_S8 has the turning on voltage level V1, such that each of the switches S1, S2, S7, and S8 remains turned on. Each of the signals Vgs_S3, Vgs_S4, Vgs_S5, and Vgs_S6 has the turning off voltage level V0, such that each of the switches S3, S4, S5, and S6 remains turned off. In some embodiments, the turning off voltage level V0 has a voltage level of 0 volt.

During the period P1, the input power source 101 provides the input voltage signal VIN to the second terminal of the switch S7 and the second terminal of the switch S8, such that the nodes N1 and N2 has an input voltage level being the same as the input voltage signal VIN. The input current signal IIN1 flows from the input power source 101 through the switch S7, and flows from the first terminal of the switch S1 into the switch S1. The input current signal IIN1 further flows from the switch S1 to the capacitor C1 to charge the capacitor C1. The input current signal IIN2 flows from the input power source 101 through the switch S8, and flows from the first terminal of the switch S2 into the switch S2. The input current signal IIN1 further flows from the switch S2 to the capacitor C2 to charge the capacitor C2.

At this moment, in response to the input current signals IIN1 and IIN2 respectively charge the capacitors C1 and C2, each of the voltage signals VC1 and VC2 keeps increasing. The voltage level VC12 of a sum of each of the voltage signals VC1 and VC2 is higher than the voltage level VINL.

At time T1, each of the signals Vgs_S2, Vgs_S7, and Vgs_S8 switches to the voltage level V0, such that each of the switches S2, S7, and S8 is turned off. When each of the switches S2, S7, and S8 is turned off, each of the signals Vgs_S4 and Vgs_S5 switches to the voltage level V1, such that each of the switches S4 and S5 is turned on.

In some circumstances, when the voltage level VC12 is higher than the voltage level VINL, and the switches S7 and S8 remain turned on, that is, the switches S7 and S8 are not implemented in the power converter 400, the reverse current signal IREV flows from the body diode of the switch S2 to the input power source 101. Similarly, the reverse current signal IREV flows through the body diode of the switch S1 to the input power source 101 as well. In the embodiments of the present disclosure, the power converter 400 similar to the power converter 100 that the power converter 400 can block the reverse current inrush generated from the reverse current signal IREV flowing to the input power source 101 by controlling the turning on and turning off of the switches S7 and S8.

Referring to FIG. 2 and FIG. 5B, during the period P2, each of the signals Vgs_S1, Vgs_S4, and Vgs_S5 has the voltage level V1, such that each of the switches S1, S4, and S5 remains turned on. Each of the signals Vgs_S2, Vgs_S3, Vgs_S6, Vgs_S7, and Vgs_S8 has the turning off voltage level V0, such that each of the switches S2, S3, S6, S7, and S8 remains turned off.

During the period P2, the voltage signal VC1 remains unchanged, and the charged capacitor C2 generates the current signal ID2. The current signal ID2 flows from the capacitor C2 through the switch S4, the node N8, and the inductor Lo2 to the node N9, and generates the output current signal Io at the node N9 to provide power to the load 102. Then, the current signal ID2 flows from the load 102 through the switch S5 and the node N7 to the capacitor C2 to form a loop. In some embodiments, since the inductors Lo2 and Lo1 are back-coupling connected, when the current signal flows through the inductor Lo2, the inductor Lo1 generates the induced current to provide power to the load 102. After the induced current of the inductor Lo1 flowed through the load 102, the induced current flows through the switch S5 to form a loop. In response to the current signal ID2 generates the output current signal Io at the node N9 to discharge to the load 102, the voltage signal VC2 keeps decreasing and the voltage level VC12 decreases correspondingly.

At time T2, when the voltage level VC12 has decreased to the voltage level VINL, each of the signals Vgs_S7 and Vgs_S8 switches from the voltage level V0 to the voltage level V1, such that each of the switch S7 and S8 is turned on.

Referring to FIG. 2 and FIG. 5C, during the period P3, each of the signals Vgs_S1, Vgs_S4, Vgs_S5, Vgs_S7, and Vgs_S8 has the turning on voltage level V1, such that each of the switches S1, S4, S5, S7, and S8 remains turned on. Each of the signals Vgs_S2, Vgs_S3, and Vgs_S6 has the turning off voltage level V0, such that each of the switches S2, S3, and S6 remains turned off.

During the period P3, the voltage level VC12 is the same as the voltage level VINL. The input current signal IIN1 flows from the input power source 101 subsequently through the switch S7, the switch S1, and the capacitor C1 to the node N8, and flows from the node N8 through the inductor Lo2 to the node N9, and generates the output current signal Io at the node N9 to provide power to the load 102. In response to the input current signal IIN1 generating the output current signal Io to provide power to the load 102, the voltage signal VC1 keeps increasing. Then, the charged capacitor C2 discharges to generate the current signal ID2. The current signal ID2 flows from the capacitor C2 through the switch S4, the node N8, and the inductor Lo2 to generate the output current signal Io to provide power to the load 102, and flows from the load 102 through the switch S5, the node N7 to the capacitor C2 to form a loop. In response to the capacitor C2 discharging, the voltage signal VC2 keeps decreasing. In the meantime, the induced current of the inductor Lo1 provides power to the load 102. After the induced current of the inductor Lo1 flowed through the load 102, the induced current flows through the switch S5 to form a loop. At this moment, the voltage signal VC1 keeps increasing, and the voltage signal VC2 keeps decreasing, the voltage level VC12 remains the same as the voltage level of the input voltage signal VIN.

In some embodiments, the output current signal Io generated at the node N9 includes the input current signal IIN1 that flows through the inductor Lo2 to the node N9, the current signal ID2 that flows through the node N8 and the inductor Lo2, and the current signal ID2 that continuously flows from the inductor Lo1.

At time T3, each of the signals Vgs_S4 and Vgs_S5 switches to the voltage level V0, such that each of the switches S4 and S5 is turned off. The signals Vgs_S2 switches to the voltage level V1, such that the switch S1 is turned on. At this moment, the power converter 100 completes a duty cycle of the switch S1 in a period between times T0 to T3.

In some embodiments, the operation of the power converter 400 in FIG. 5D to FIG. 5F and during the periods P4-P6 is similar to the operation in FIG. 5A to FIG. 5C and the periods P1-P3. The similar parts of the operation are not repeated herein for simplicity.

Referring to FIG. 2 and FIG. 5D, during the period P4, each of the signals Vgs_S1, Vgs_S2, Vgs_S7, and Vgs_S8 has the turning on voltage level V1, such that each of the switches S1, S2, S7, and S8 remains turned on. Each of the signals Vgs_S3, Vgs_S4, Vgs_S5, and Vgs_S6 has the turning off voltage level V0, such that each of the switches S3, S4, S5, and S6 remains turned off.

During the period P4, in response to each of the switches S7 and S8 being turned on, the input current signals IIN1 and IIN2 charge the capacitors C1 and C2.

At time T4, each of the signals Vgs_S1, Vgs_S7, and Vgs_S8 switches to the voltage level V0, such that each of the switches S1, S7, and S8 is turned off. When each of the switches S1, S7, and S8 has been turned off, each of the signals Vgs_S3 and Vgs_S6 switches to the voltage level V1, such that each of the switches S3 and S6 is turned on.

Referring to FIG. 2 and FIG. 5E, during the period P5, each of the signals Vgs_S2, Vgs_S3, and Vgs_S6 has the turning on voltage level V1, such that each of the switches S2, S3, and S6 remains turned on. Each of the signals Vgs_S1, Vgs_S4, Vgs_S5, Vgs_S7, and Vgs_S8 has the turning off voltage level V0, such that each of the switches S1, S4, S5, S7, and S8 remains turned off.

During the period P5, the voltage signal VC2 remains unchanged, and the charged capacitor C1 generates the current signal ID1. The current signal ID1 flows from the capacitor C1 through the switch S3, the node N7, and the inductor Lo1 to the node N9, and generates the output current signal Io at the node N9 to provide power to the load 102. Then, the current signal ID1 flows from the load 102 through the switch S6, the node N8 to the capacitor C1 to form a loop. In some embodiments, since the inductor Lo2 and Lo1 is back-coupling connected, when the current signal flows through the inductor Lo1, the inductor Lo2 generates the induced current to provide power to the load 102. After the induced current of the inductor Lo2 flowed through the load 102, the induced current flows through the switch S6 to form a loop. In response to the current signal ID1 generates the output current signal Io at the node N9 to discharge to the load 102, the voltage level VC12 decreases correspondingly.

At time T2, when the voltage level VC12 has decreased to the voltage level VINL, each of the signals Vgs_S7 and Vgs_S8 switches from the voltage level V0 to the voltage level V1, such that each of the switches S7 and S8 is turned on.

Referring to FIG. 2 and FIG. 5F, during the period P6, each of the signals Vgs_S2, Vgs_S3, Vgs_S6, Vgs_S7, and Vgs_S8 has the turning on voltage level V1, such that each of the switches S1, S3, S6, S7, and S8 remains turned on. Each of the signals Vgs_S1, Vgs_S4, and Vgs_S5 has the turning off voltage level V0, such that each of the switches S1, S4, and S5 remains turned off.

During the period P6, the voltage level VC12 is the same as the voltage level VINL. The input current signal IIN2 flows from the input power source 101 subsequently through the switch S8, the switch S2, and the capacitor C2 to the node N7, and flows from the node N7 through the inductor Lo1 to the node N9, and generates the output current signal Io at the node N9 to provide power to the load 102. In response to the input current signal IIN2 generating the output current signal Io to provide power to the load 102, the voltage signal VC2 keeps increasing. Then, the charged capacitor C1 discharges to generate the current signal ID1. The current signal ID1 flows from the capacitor C1 through the switch S3, the node N7, and the inductor Lo1, and generates the output current signal Io to provide power to the load 102, and flows from the load 102 through the switch S6 and the node N8 to the capacitor C1 to form a loop. In response to the capacitor C1 discharging, the voltage signal VC1 keeps decreasing. In the meantime, the induced current of the inductor Lo2 provides power to the load 102. After the induced current of the inductor Lo1 flowed through the load 102, the induced current flows through the switch S6 to form a loop. At this moment, the voltage signal VC2 keeps increasing, and the voltage signal VC1 keeps decreasing. The voltage level VC12 remains the same as the voltage level of the input voltage signal VIN.

In some embodiments, the output current signal Io generated at the node N9 includes the input current signal IIN2 that flows through the inductor Lo1 to the node N9, the current signal ID1 that flows through the node N7 and the inductor Lo1, and the current signal ID1 that continuously flows from the inductor Lo2. The input current signal IIN2 further flows from the node N7 subsequently through the switch S3 and the capacitor C1 to the node N8, and flows from the node N8 through the switch S6 to the input power source 101 to form a loop, and flows from the node N8 through the inductor Lo2 to the node N9. The input current signal IIN2 that flows through the inductors Lo1 and Lo2 generates the output current signal Io at the node N9 to provide power to the load 102.

At time T6, each of the signals Vgs_S3 and Vgs_S6 switches to the voltage level V0, such that each of the switches S3 and S6 is turned off. The signals Vgs_S1 switches to the voltage level V1, such that the switch S1 is turned on. At this moment, the power converter 400 completes a duty cycle of the switch S2 during the periods P4-P6.

In some embodiments, when the power converter 400 has completed the duty cycles of the switches S1 and S2, the power converter 400 subsequently repeats the next duty cycle of the switches S1 and S2. In some embodiments, the operation of the power converter 400 after time T9 can be extended to multiple operations similar to the period between times T0 and T9, but the present disclosure is not limited to the operation between time T0 to time T9.

In some embodiments, when the power converter 100 and/or 400 is operating, the power converter 100 and/or 400 can subsequently complete one duty cycle of the switch S1, one duty cycle of the switch S2, and repeats the duty cycles of the switches S1 and S2 alternatively.

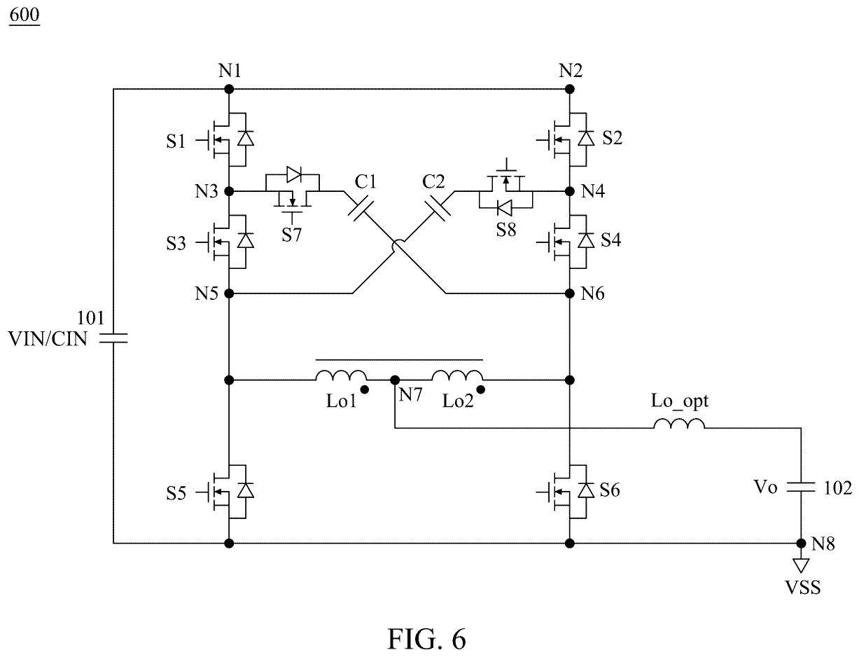

FIG. 6 is a circuit diagram of a power converter 600, illustrated in accordance with some embodiments of the present disclosure. The power converter 600 is another embodiment of the power converters 100 and 400. As shown in FIG. 6, the power converter 600 includes the input power source 101, the load 102, the capacitors C1 and C2, the inductors Lo1, Lo2, and Lo_opt, and the switches S1-S8. Wherein, the input power source 101 includes the input capacitor CIN. Wherein, when the inductors Lo1 and Lo2 are totally back-coupling connected, a terminal of the inductor Lo_opt is coupled between the inductors Lo1 and Lo2, another terminal of the inductor Lo_opt is coupled to the load 102. When the inductors Lo1 and Lo2 are partially back-coupling connected, the inductor Lo_opt can be selectively neglected in the power converter 600.

In some embodiments, the coupling relationship of the power converter 600 is similar to the power converters 100 and 400. Referring to FIG. 6, FIG. 4 and FIG. 1, the difference of the power converter 600 compared to the power converters 100 and 400 is the location of the switches S7 and S8. Wherein, the switches S7 and S8 are connected in series to the capacitors C1 and C2, respectively.

As shown in FIG. 6, the first terminal of the switch S1 is coupled to the input power source 101 at the node N1, and is configured to receive the input voltage signal VIN. The second terminal of the switch S1 is coupled to the second terminal of the switch S7 at the node N3, and the first terminal of the switch S7 is coupled to a terminal of the capacitor C1. Another terminal of the capacitor C1 is coupled to the second terminal of the switch S4 at the node N6. The first terminal of the switch S2 is coupled to the input power source 101 at the node N2, and is configured to receive the input voltage signal VIN. The second terminal of the switch S2 is coupled to the second terminal of the switch S8 at the node N4, and the first terminal of the switch S8 is coupled to a terminal of the capacitor C2. Another terminal of the capacitor C2 is coupled to the second terminal of the switch S3 at the node N5. The first terminal of the switch S3 is coupled to the switches S1 and S7 at the node N3. The first terminal of the switch S4 is coupled to the switches S2 and S8 at the node N4.

In some embodiments, a terminal of the inductor Lo1 is coupled to the switch S3 at the node N5, and another terminal of the inductor Lo1 is coupled to the node N7. A terminal of the inductor Lo2 is coupled to the switch S4 at the node N6, and another terminal of the inductor Lo2 is coupled to the node N7. A terminal of the load 102 is coupled to the inductors Lo1 and Lo2 at the node N7, another terminal of the load 102 is coupled to the node N8 and is configured to receive the reference voltage signal VSS. The first terminal of the switch S5 is coupled to the inductor Lo1 at the node N5, the second terminal of the switch S5 is coupled to the node N8. The first terminal of the switch S6 is coupled to the inductor Lo2 at the node N6, the second terminal of the switch S6 is coupled to the node N8. The node N8 is further coupled to another terminal of the input power source 101 and forms a loop. In some embodiments, the reference voltage signal VSS has the ground voltage level.

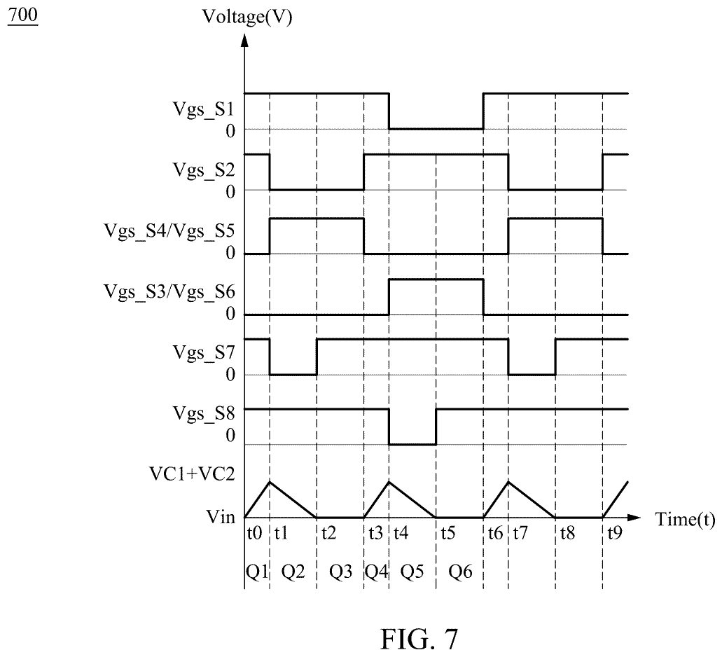

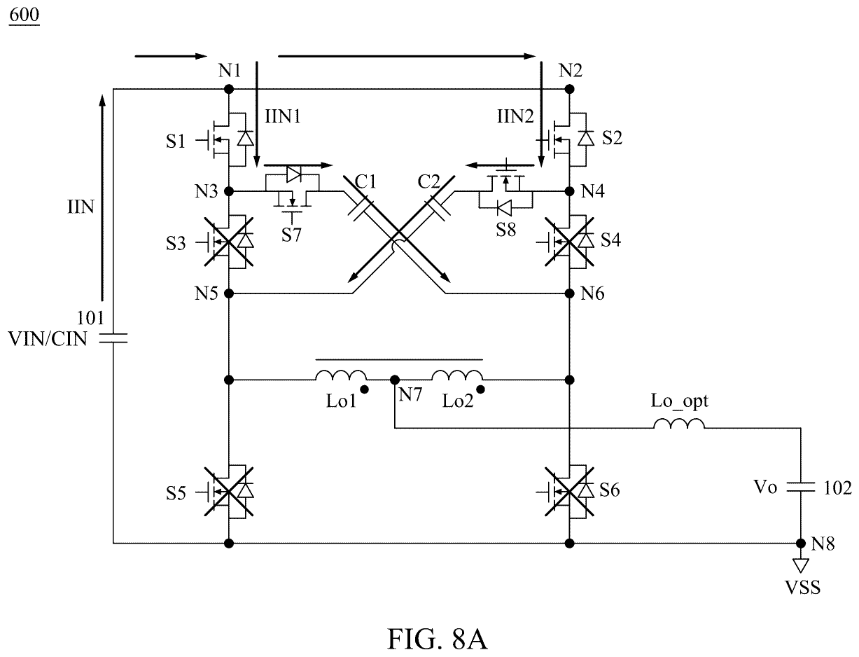

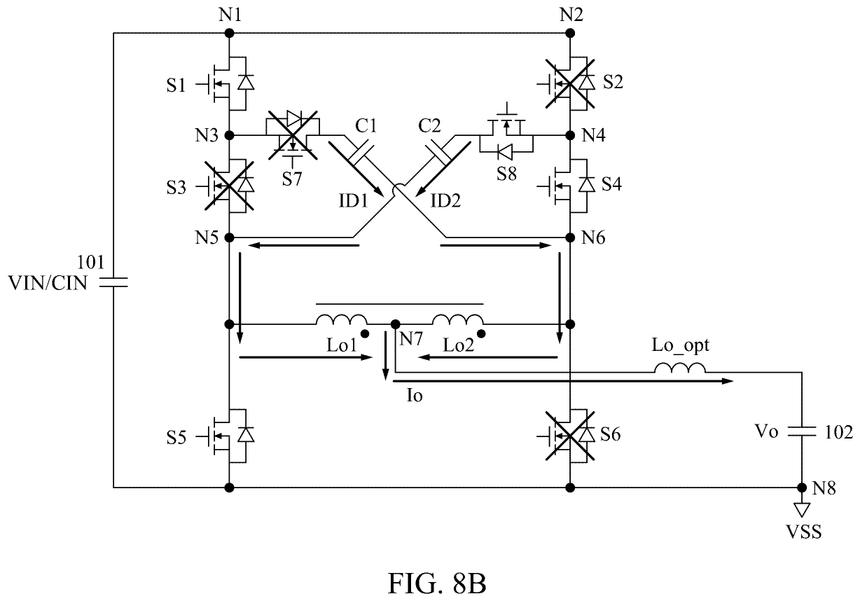

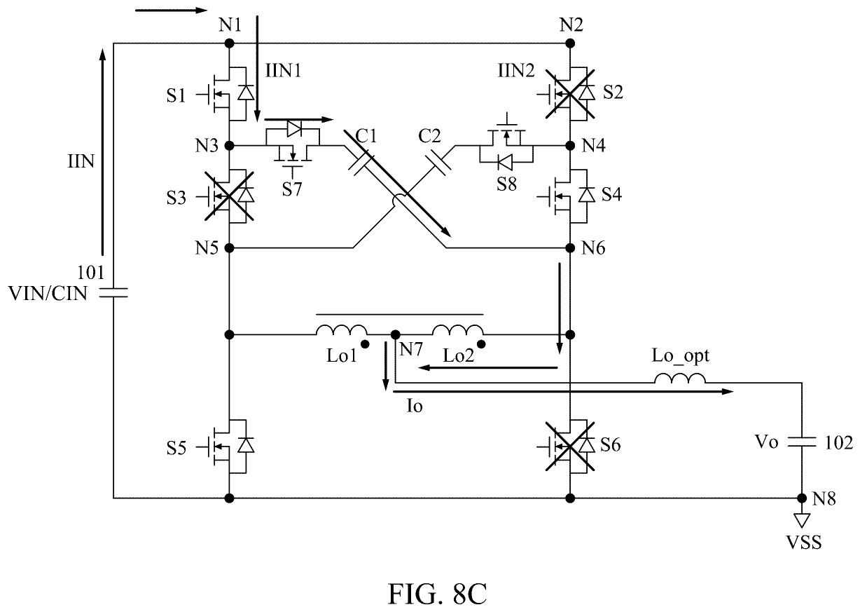

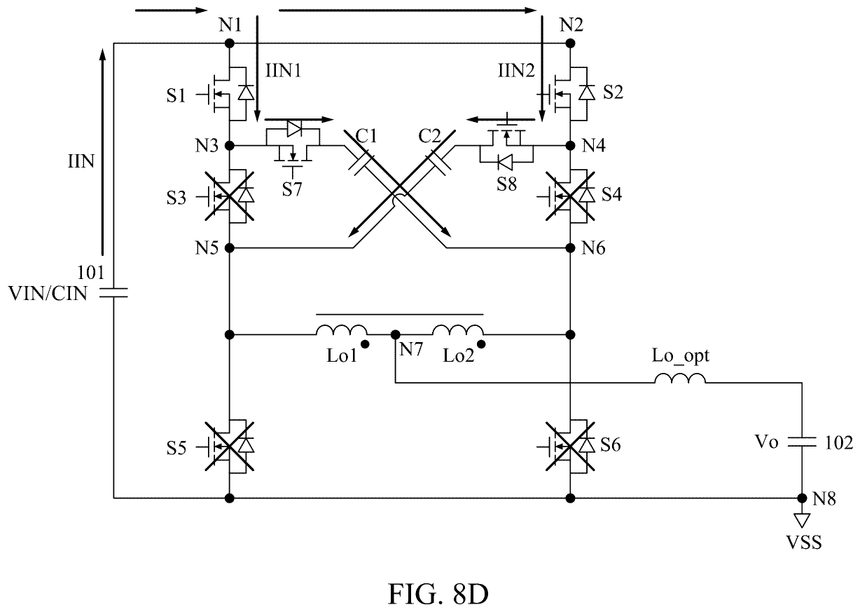

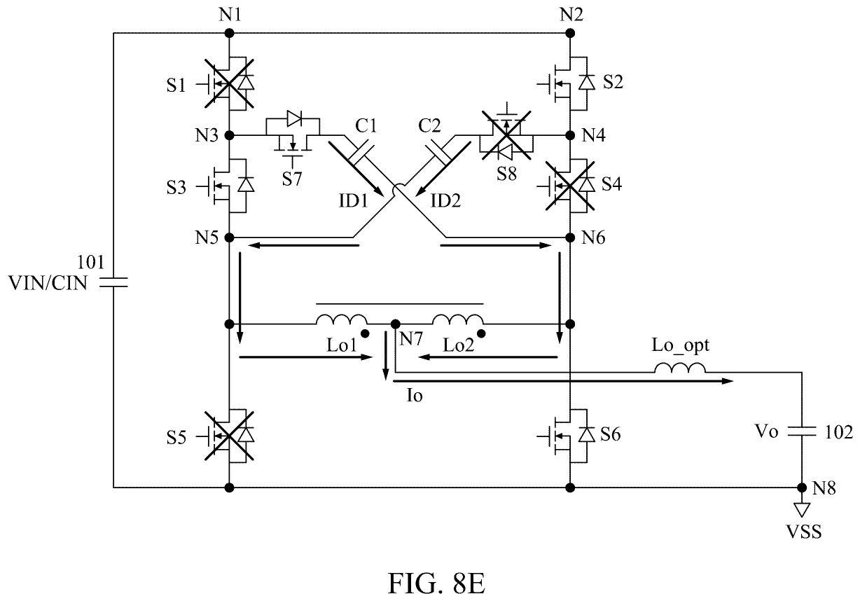

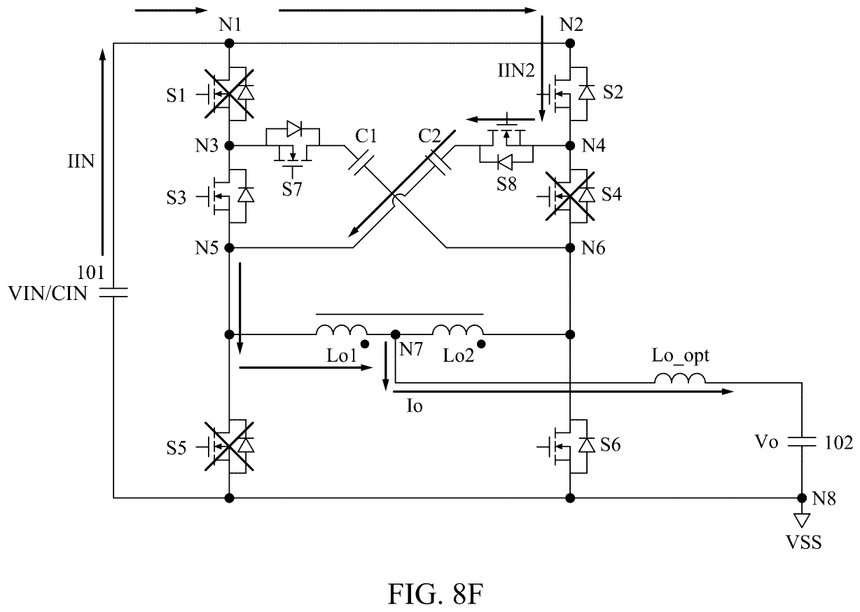

In some embodiments, the input power source 101 is configured to impose the input voltage signal VIN to the switches S1 and S2, and respectively generates the input current signals IIN1 and IIN2. The input current signals IIN1 and IIN2 generate the output current signal Io at the node N9. The output current signal Io flows to the load 102 to provide power to the load 102. The operation of the power converter 600 is similar to the power converters 100 and 400, the similarities of the power converter 600 are not repeated herein for simplicity. Further details regarding the operations of the power converter 600 are discussed in FIG. 7, FIG. 8A to FIG. 8F, and the corresponding paragraphs of the present disclosure.

In the embodiments of the present disclosure, the power converter 600 is similar to the power converters 100 and 400. The power converter 600 is further arranged with the switches S7 and S8 that respectively connected in series to the capacitors C1 and C2. The power converter 600 having the switches S7 and S8 can depress the voltage signals VC1 and VC2 of the capacitors C1 and C2, such that the voltage signals VC1 and VC2 can be effectively decreased. In the circumstance that the voltage level VINL is four times lower than the voltage level of the voltage signal Vo, the power converter 600 can achieve the purpose of lowering the voltage signal of the capacitor, and further depress the reverse current inrush generated by the voltage signal of the capacitor.

FIG. 7 is a timing diagram 700 of controlling the power converter 600, illustrated in accordance with some embodiments of the present disclosure. As shown in FIG. 7, the timing diagram 700 illustrates the operation of the power converter 600 during a period between times T0 to T9.

Referring to FIG. 6 and FIG. 7, the timing diagram 700 illustrates the changes of the signals Vgs_S1-Vgs_S8, and the voltage level VC12 of a sum of the voltage level of the voltage signal VC1 and the voltage level of the voltage signal VC2 with respect to time.

FIG. 8A to FIG. 8F are circuit diagrams of the power converter 600 operated in different periods of time, illustrated in accordance with some embodiments of the present disclosure. FIG. 8A corresponds to a period Q1 between times T0 and T1. FIG. 8B corresponds to a period Q2 between times T1 and T2. FIG. 8C corresponds to a period Q3 between times T2 and T3. FIG. 8D corresponds to a period Q4 between times T3 and T4. FIG. 8E corresponds to a period Q5 between times T4 and T5. FIG. 8F corresponds to a period Q6 between times T5 and T6. Wherein, a period between times T6 and T7, a period between times T7 and T8, and a period between times T8 and T9 can be referred to FIG. 8A to FIG. 8C, respectively.

In some embodiments, FIG. 8A to FIG. 8C and the corresponding periods Q1-Q3 are a duty cycle of the switch S1. FIG. 8D to FIG. 8F and the corresponding periods Q4-Q6 are a duty cycle of the switch S2.

Referring to FIG. 7 and FIG. 8A, during the period Q1, each of the signals Vgs_S1, Vgs_S2, Vgs_S7, and Vgs_S8 has the voltage level V1, such that each of the switches S1, S2, S7, and S8 remains turned on. Each of the signals Vgs_S3, Vgs_S4, Vgs_S5, and Vgs_S6 has the voltage level V0, such that each of the switches S3, S4, S5, and S6 remains turned off.

During the period Q1, the input power source 101 provides the input voltage signal VIN to the first terminal of the switch S1 and the first terminal of the switch S2, such that the nodes N1 and N2 have the voltage level VINL. The input current signal IIN1 flows through the switch S1, and flows from the second terminal of the switch S7 into the switch S7. The input current signal IIN1 further flows from the switch S7 to the capacitor C1 to charge the capacitor C1. The input current signal IIN2 flows from the switch S2 through the second terminal of the switch S8 into the switch S8. The input current signal IIN1 further flows from the switch S8\ to the capacitor C2 to charge the capacitor C2.

At this moment, in response to the input current signals IIN1 and IIN2 respectively charging the capacitors C1 and C2, each of the voltage signals VC1 and VC2 keeps increasing. The voltage level VC12 of the sum of each of the voltage signals VC1 and VC2 is higher than the voltage level VINL.

At time T1, each of the signals Vgs_S2 and Vgs_S7 switches to the voltage level V0, such that each of the switches S2 and S7 is turned off. When each of the switches S2 and S7 has been turned off, each of the signals Vgs_S4 and Vgs_S5 switches to the voltage level V1, such that each of the switches S4 and S5 is turned on.

In some circumstances, when the voltage level VC12 is higher than the voltage level VINL, and the switch S7 remains turned on, that is, the switch S7 is not implemented in the power converter 600, the reverse current signal IREV flows from the body diodes of the switches S1 and S2 to the input power source 101. As a result, the reverse current signal IREV generates a reverse current inrush to the input power source 101, causing damage to the power converter. In some embodiments of the present disclosure, the power converter 100 can block the reverse current signal IREV which flows to the input power source 101 generating the reverse current inrush by turning off the switches S7 or S8.

Referring to FIG. 7 and FIG. 8B, during the period Q2, each of the signals Vgs_S1, Vgs_S4, Vgs_S5, and Vgs_S8 has the voltage level V1, such that each of the switches S1, S4, S5, and S8 remains turned on. Each of the signals Vgs_S2, Vgs_S3, Vgs_S6, and Vgs_S7 has the voltage level V0, such that each of the switches S2, S3, S6, and S7 remains turned off.

During the period Q2, the voltage signal VC1 remains unchanged, and the charged capacitor C2 generates the current signal ID2, the current signal ID2 flows from the capacitor C2 through the switches S8 and S4, the node N6, and the inductor Lo2 to the node N7, and generates the output current signal Io at the node N7 to provide power to the load 102. Then, the current signal ID2 flows from the load 102 through the switch S5 and the node N7 to the capacitor C2 to form a loop. In some embodiments, since the inductors Lo2 and Lo1 are back-coupling connected, when the current signal flows through the inductor Lo2, the inductor Lo1 generates the induced current signal to provide power to the load 102. After the induced current of the inductor Lo1 flowed to the load 102, the induced current flows through the switch S5 to form a loop.

At time T2, when the voltage level VC12 decreases to the voltage level VINL, the signals Vgs_S7 switches from the voltage level V0 to the voltage level V1, such that the switch S7 is turned on.

Referring to FIG. 7 and FIG. 8C, during the period Q3, each of the signals Vgs_S1, Vgs_S4, Vgs_S5, Vgs_S7, and Vgs_S8 has the turning on voltage level V1, such that each of the switches S1, S4, S5, S7, and S8 remains turned on. Each of the signals Vgs_S2, Vgs_S3, and Vgs_S6 has the turning off voltage level V0, such that each of the switches S2, S3, and S6 remains turned off.

During the period Q3, the voltage level VC12 is the same as the voltage level VINL. The input current signal IIN1 flows from the input power source 101 subsequently through the switch S1, the switch S7, and the capacitor C1 to the node N6, and flows from the node N6 through the inductor Lo2 to the node N7, and generates the output current signal Io at the node N7 to provide power to the load 102. In response to the input current signal IIN1 generating the output current signal Io to provide power to the load 102, the voltage signal VC1 keeps increasing. Then, the charged capacitor C2 discharges to generate the current signal ID2. The current signal ID2 flows from the capacitor C2 through the switch S4, the node N6, and the inductor Lo2, and generates the output current signal Io to provide power to the load 102, and flows from the load 102 through the switch S5, the node N5 to the capacitor C2 to form a loop. In response to the capacitor C2 discharging, the voltage signal VC2 keeps decreasing. At this moment, the voltage signal VC1 keeps increasing, and the voltage signal VC2 keeps decreasing. The voltage level VC12 remains the same as the voltage level of the input voltage signal VIN.

Then, at time T3, each of the signals Vgs_S4 and Vgs_S5 switches to the voltage level V0, such that each of the switches S4 and S5 is turned off. The signal Vgs_S2 switches to the voltage level V1, such that the switch S2 is turned on. At this moment, the power converter 600 completes a duty cycle of the switch S1 during the periods Q1-Q3.

In some embodiments, the operation of the power converter 600 in FIG. 8D to FIG. 8F and the periods Q4-Q6 is similar to the operation in FIG. 8A to FIG. 8C and the periods Q1-Q3. The similar parts of the operation are not repeated herein for simplicity.

Referring to FIG. 7 and FIG. 8D, during the period Q4, each of the signals Vgs_S1, Vgs_S2, Vgs_S7, and Vgs_S8 has the turning on voltage level V1, such that each of the switches S1, S2, S7, and S8 remains turned on. Each of the signals Vgs_S3, Vgs_S4, Vgs_S5, and Vgs_S6 has the turning off voltage level V0, such that each of the switches S3, S4, S5, and S6 remains turned off.

During the period Q4, in response to each of the switches S7 and S8 being turned on, the input current signals IIN1 and IIN2 charge the capacitors C1 and C2, respectively.

At time T4, each of the signals Vgs_S1 and Vgs_S8 switches to the voltage level V0, such that each of the switches S1 and S8 is turned off. When each of the switches S1 and S8 has been turned off, each of the signals Vgs_S3 and Vgs_S6 switches to the voltage level V1, such that each of the switches S3 and S6 is turned on.

Referring to FIG. 7 and FIG. 8E, during the period Q5, each of the signals Vgs_S2, Vgs_S3, Vgs_S6, and Vgs_S7 has the turning on voltage level V1, such that each of the switches S2, S3, S6, and S7 remains turned on. Each of the signals Vgs_S1, Vgs_S4, Vgs_S5, and Vgs_S8 has the turning off voltage level V0, such that each of the switches S1, S4, S5, and S8 remains turned off.

During the period Q5, the voltage signal VC2 remains unchanged, and the charged capacitor C1 generates the current signal ID1. The current signal ID1 flows from the capacitor C1 through the switch S3, the node N5, and the inductor Lo1 to the node N7, and generates the output current signal Io at the node N7 to provide power to the load 102. Then, the current signal ID1 flows from the load 102 through the switch S and the node N6 to the capacitor C1 to form a loop. In some embodiments, since the inductors Lo2 and Lo1 are back-coupling connected, when the current signal flows through the inductor Lo1, the inductor Lo2 generates the induced current signal to provide power to the load 102. After the induced current of the inductor Lo2 flowed through the load 102, the induced current flows through the switch S6 to form a loop.

At time T2, when the voltage level VC12 decreases to the voltage level VINL, the signal Vgs_S8 switches from the voltage level V0 to the voltage level V1, such that the switch S8 is turned on.

Referring to FIG. 7 and FIG. 8F, during the period Q6, each of the signals Vgs_S2, Vgs_S3, Vgs_S6, Vgs_S7, and Vgs_S8 has the turning on voltage level V1, such that each of the switches S1, S3, S6, S7, and S8 remains turned on. Each of the signals Vgs_S1, Vgs_S4, and Vgs_S5 has the turning off voltage level V0, such that each of the switches S1, S4, and S5 remains turned off.

During the period Q6, the voltage level VC12 is the same as the voltage level VINL. The input current signal IIN2 flows from the input power source 101 subsequently through the switch S2, the switch S8, and the capacitor C2 to the node N5, and flows from the node N5 through the inductor Lo1 to the node N7, and generates the output current signal Io at the node N7 to provide power to the load 102. In response to the input current signal IIN2 generating the output current signal Io to provide power to the load 102, the voltage signal VC2 keeps increasing. Then, the charged capacitor C1 discharges to generate the current signal ID1. The current signal ID1 flows from the capacitor C1 through the switch S3, the node N5, and the inductor Lo1, and generates the output current signal Io to provide power to the load 102, and flows from the load 102 through the switch S6 and the node N6 to the capacitor C1 to form a loop. In response to the capacitor C1 discharging, the voltage signal VC1 keeps decreasing. In the meantime, the induced current of the inductor Lo2 provides power to the load 102. After the induced current of the inductor Lo1 flowed through the load 102, the induced current flows through the switch S6 to form a loop. At this moment, the voltage signal VC2 keeps increasing, and the voltage signal VC1 keeps decreasing. The voltage level VC12 remains the same as the voltage level of the input voltage signal VIN.

At time T6, each of the signals Vgs_S3 and Vgs_S6 switches to the voltage level V0, such that each of the switches S3 and S6 is turned off. The signals Vgs_S1 switches to the voltage level V1, such that the switch S1 is turned on. At this moment, the power converter 600 completes a duty cycle of the switch S2 during the period Q4-Q6.

In some embodiments, when the power converter 600 has completed the duty cycles of the switches S1 and S2, the power converter 600 subsequently repeats the next duty cycle of the switches S1 and S2. In some embodiments, the operation of the power converter 600 after time T9 can be extended to multiple operations similar to the period between times T0 and T9, but the present disclosure is not limited to the operation between time T0 to time T9.

In some embodiments, when the power converter 600 is operating, the power converter 600 can subsequently complete one duty cycle of the switch S1, one duty cycle of the switch S2, and repeats the duty cycles of the switches S1 and S2 alternatively.

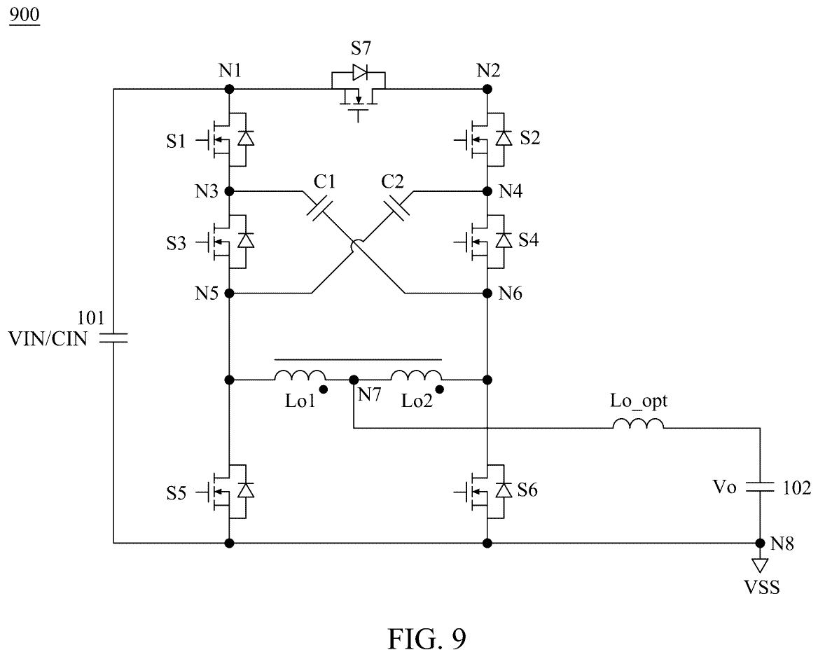

FIG. 9 is a circuit diagram of a power converter 900, illustrated in accordance with some embodiments of the present disclosure. The power converter 900 is another embodiment of the power converters 100, 400, and 600. As shown in FIG. 9, the power converter 900 includes the input power source 101, the load 102, the capacitors C1 and C2, the inductors Lo1, Lo2, and Lo_opt, and the switches S1-S7. Wherein, the input power source 101 includes the input capacitor CIN. Wherein, when the inductors Lo1 and Lo2 are totally back-coupling connected, a terminal of the inductor Lo_opt is coupled between to the inductors Lo1 and Lo2, and another terminal of the inductor Lo_opt is coupled to the load 102. When the inductors Lo1 and Lo2 are partially back-coupling connected, the inductor Lo_opt can be selectively neglected in the power converter 900.

In some embodiments, the coupling relationship of the power converter 900 is similar to the power converters 100, 400, and 600. Referring to FIG. 9, FIG. 6, FIG. 4, and FIG. 1, the difference of the power converter 900 compared to the power converters 100, 400, and 600 is that the power converter 900 includes the switch S1-S7. Wherein, the switch S7 is connected in series between the switches S1 and S2.

As shown in FIG. 9, the first terminal of the switch S1 is coupled to the input power source 101 at the node N1, and is configured to receive the input voltage signal VIN. The second terminal of the switch S1 is coupled to the first terminal of the switch S3 at the node N3. The first terminal of the switch S2 is coupled to the first terminal of the switch S7 at the node N2, the second terminal of the switch S2 is coupled to the first terminal of the switch S4 at the node N4. The second terminal of the switch S7 is coupled to the first terminal of the switch S1 at the node N1. A terminal of the capacitor C1 is coupled to the second terminal of the switch S1, another terminal of the capacitor C1 is coupled to the second terminal of the switch S4 at the node N6. A terminal of the capacitor C2 is coupled to the second terminal of the switch S2, another terminal of the capacitor C2 is coupled to the second terminal of the switch S3 at the node N5.

In some embodiments, a terminal of the inductor Lo1 is coupled to the switch S3 at the node N5, and another terminal of the inductor Lo1 is coupled to the node N7. A terminal of the inductor Lo2 is coupled to the switch S4 at the node N6, and another terminal of the inductor Lo2 is coupled to the node N7. A terminal of the load 102 is coupled to the inductors Lo1 and Lo2 at the node N7, another terminal of the load 102 is coupled to the node N8 and is configured to receive the reference voltage signal VSS. The first terminal of the switch S5 is coupled to the switch S3, the second terminal of the switch S5 is coupled to the node N8. The first terminal of the switch S6 is coupled to the switch S4, the second terminal of the switch S6 is coupled to the node N8. The node N8 is further coupled to another terminal of the input power source 101 and forms a loop. In some embodiments, the reference voltage signal VSS has the ground voltage level.

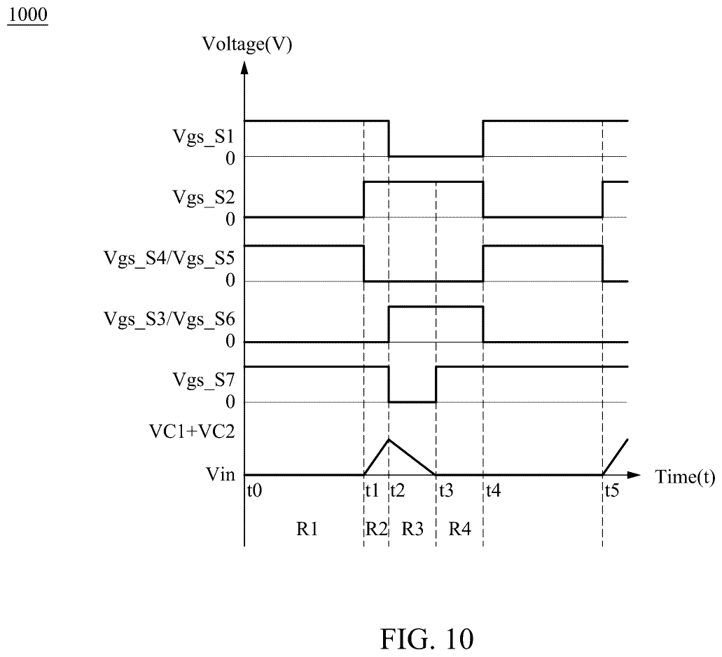

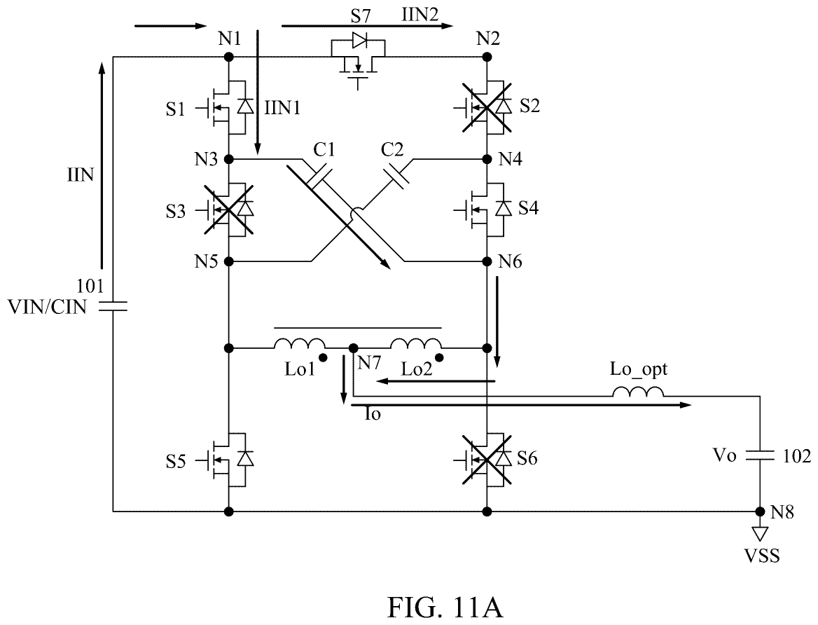

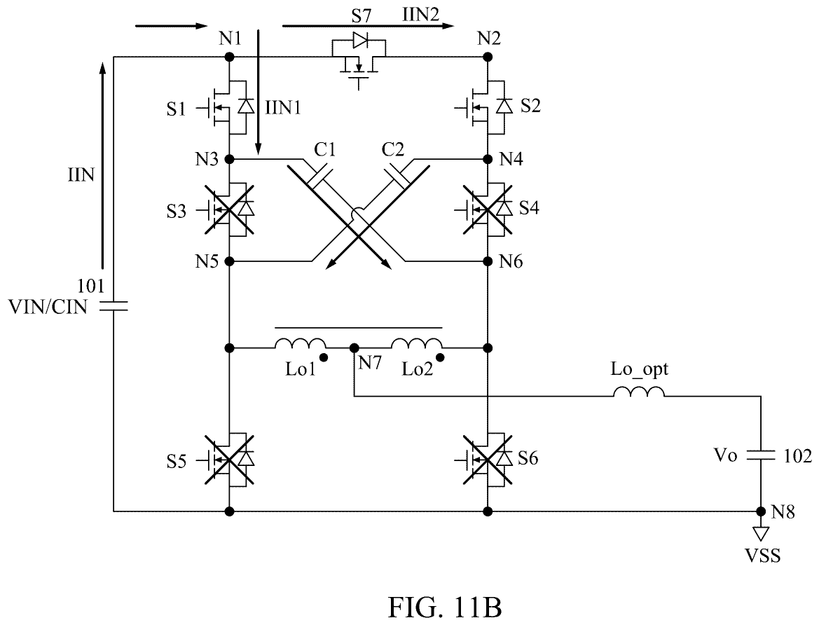

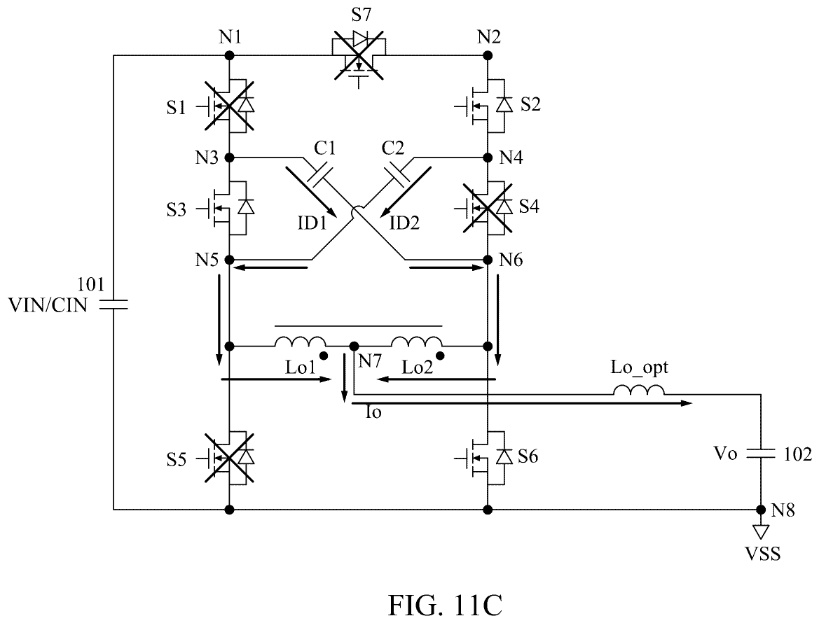

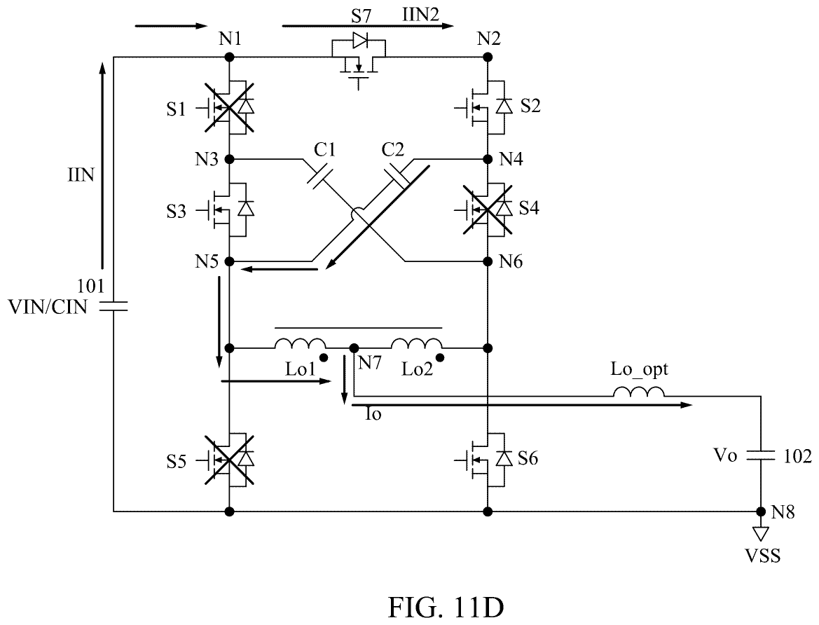

In some embodiments, the input power source 101 is configured to impose the input voltage signal VIN to the switches S1 and S7, and respectively generates the input current signals IIN1 and IIN2. Wherein, when the switch S7 is turned on, the input current signal IIN2 further flows from the switch S7 through the node N2 to the switch S2. The input current signals IIN1 and IIN2 generate the output current signal Io at the node N7. The output current signal Io flows to the load 102 to provide power to the load 102. The operation of the power converter 900 is similar to the power converters 100, 400, and 600. The similar parts of the power converter 900 are not repeated herein for simplicity. Further details regarding the operation of the power converter 900 are discussed in FIG. 10, FIG. 11A to FIG. 11D, and the corresponding paragraphs of the present disclosure.

In the embodiments of the present disclosure, the power converter 900 has the similar technical effects as the power converters 100, 400, and 600. The power converter 900 is further arranged with the switch S7 coupled in series between the switches S1 and S2. The power converter 900 having the switch S7 can depress the voltage signals VC1 and VC2 of the capacitors C1 and C2, such that the voltage signals VC1 and VC2 can be effectively decreased. In the circumstance that the voltage level VINL is four times lower than the voltage level of the voltage signal Vo, the power converter 900 can achieve the purpose of lowering the voltage signal of the capacitor, and further depress the reverse current inrush generated by the voltage signal of the capacitor as well. In some embodiments, when the power converter 900 is operating, the purpose that the output voltage signal Vo being equal to one fourth of the input voltage signal VIN can be achieved by limiting the duty ratio of the switch S2 to 0.5.

FIG. 10 is a timing diagram 1000 of controlling the power converter 900, illustrated in accordance with some embodiments of the present disclosure. As shown in FIG. 10, the timing diagram 1000 illustrates the operation of the power converter 900 in a period between times T0 to T5.

Referring to FIG. 9 and FIG. 10, the timing diagram 1000 illustrates the changes of the signals Vgs_S1-Vgs_S7, and the voltage level VC12 of a sum of the voltage level of the voltage signal VC1 and the voltage level of the voltage signal VC2 with respect to time.

FIG. 11A to FIG. 11D are circuit diagrams of the power converter 900 operated in different periods of time, illustrated in accordance with some embodiments of the present disclosure. FIG. 11A corresponds to a period R1 between times T0 and T1. FIG. 11B corresponds to a period R2 between times T1 and T2. FIG. 11C corresponds to a period R3 between times T2 and T3. FIG. 11D corresponds to a period R4 between times T3 and T4.

Referring to FIG. 10 and FIG. 11A, during the period R1, each of the signals Vgs_S1, Vgs_S4, Vgs_S5, and Vgs_S7 has the voltage level V1, such that each of the switches S1, S4, S5, and S7 remains turned on. Each of the signals Vgs_S2, Vgs_S3, and Vgs_S6 has the voltage level V0, such that each of the switches S2, S3, and S6 remains turned off.

During the period R1, the input power source 101 provides the input voltage signal VIN to the first terminal of the switch S1 and the second terminal of the switch S7, such that the node N1 has the voltage level VINL. The input current signal IIN1 flows through the switch S1 to the capacitor C1, and charges the capacitor C1. Then, the charged capacitor C2 discharges to generate the current signal ID2. The current signal ID2 flows from the capacitor C2 through the switch S4, the node N6, and the inductor Lo2, and generates the output current signal Io to provide power to the load 102, and flows from the load 102 through the switch S5 and the node N5 to the capacitor C2 to form a loop. In response to the capacitor C2 discharging, the voltage signal VC2 keeps decreasing. In the meantime, the induced current of the inductor Lo1 provides power to the load 102. After the induced current of the inductor Lo1 flowed through the load 102, the induced current flows through the switch S5 to form a loop. At this moment, the voltage signal VC1 keeps increasing, and the voltage signal VC2 keeps decreasing, the voltage level VC12 remains the same as the voltage level of the input voltage signal VIN.

At time T1, the signals Vgs_S2 switches to the voltage level V1, such that the switch S2 is turned on. Each of the signals Vgs_S4 and Vgs_S5 switches to the voltage level V0, such that each of the switches S4 and S5 is turned off.

Referring to FIG. 10 and FIG. 11B, during the period R2, each of the signals Vgs_S1, Vgs_S2, and Vgs_S7 has the voltage level V1, such that each of the switches S1, S2, and S7 remains turned on. Each of the signals Vgs_S3, Vgs_S4, Vgs_S5, and Vgs_S6 has the voltage level V0, such that each of the switches S3, S4, S5, and S6 remains turned off.

During the period R2, in response to the switch S2 being turned on, the switch S2 receives the input voltage signal VIN and generates the input current signal IIN2. The input current signal IIN2 flows from the switch S7 through the switch S2 to the capacitor C2 and charges the capacitor C2.

At this moment, in response to the input current signals IIN1 and IIN2 respectively charging the capacitors C1 and C2, each of the voltage signals VC1 and VC2 keeps increasing. The voltage level VC12 of a sum of each of the voltage signals VC1 and VC2 is higher than the voltage level VINL.

At time T2, each of the signals Vgs_S1 and Vgs_S7 switches to the voltage level V0, such that each of the switches S1 and S7 is turned off. When each of the switches S1 and S7 has been turned off, each of the signals Vgs_S3 and Vgs_S6 switches to the voltage level V1, such that each of the switches S3 and S6 is turned on.

In some circumstances, when the voltage level VC12 is higher than the voltage level VINL and the switch S7 remains turned on, that is, when the switch S7 is not implemented in the power converter 900, the reverse current signal IREV flows through the body diode of the switch S2 to the input power source 101. The reverse current signal generates a reverse current inrush to the input power source 101, causing damage to the power converter. In some embodiments of the present disclosure, the power converter 900 can block the reverse current signal IREV which flows to the input power source 101 generating the reverse current inrush by turning off the switch S7.

Referring to FIG. 10 and FIG. 11C, during the period R3, each of the signals Vgs_S2, Vgs_S3, and Vgs_S6 has the voltage level V1, such that each of the switches S2, S3, and S6 remains turned on. Each of the signals Vgs_S1, Vgs_S4, Vgs_S5, and Vgs_S7 the voltage level V0, such that each of the switches S1, S4, S5, and S7 remains turned off.

During the period R3, the voltage signal VC2 remains unchanged, and the charged capacitor C1 generates the current signal ID1. The current signal ID1 flows from the capacitor C1 through the switch S3, the node N5, and the inductor Lo1 to the node N7, and generates the output current signal Io at the node N7 to provide power to the load 102. Then, the current signal ID1 flows from the load 102 through the switch S6 and the node N6 to the capacitor C1 to form a loop. In some embodiments, since the inductors Lo2 and Lo1 is back-coupling connected, when the current signal flows through the inductor Lo1, the inductor Lo2 generates the induced current to provide power to the load 102. After the induced current of the inductor Lo2 flowed through the load 102, the induced current flows through the switch S6 to form a loop. At this moment, in response to the current signal ID1 generating the output current signal Io at the node N7 to discharge to the load 102, the voltage signal VC1 keeps decreasing, and the voltage level VC12 decreases correspondingly.

At time T3, when the voltage level VC12 decreases to the voltage level VINL, the signals Vgs_S7 switches from the voltage level V0 to the voltage level V1, such that the switch S7 is turned on.

Referring to FIG. 10 and FIG. 11D, during the period R4, each of the signals Vgs_S2, Vgs_S3, Vgs_S6, and Vgs_S7 has the turning on voltage level V1, such that each of the switches S2, S3, S6, and S7 remains turned on. each of the signals Vgs_S1, Vgs_S4, and Vgs_S5 has the turning off voltage level V0, such that each of the switches S1, S4, and S5 remains turned off.

During the period R4, the voltage level VC12 is the same as the voltage level VINL. The input current signal IIN2 flows from the input power source 101 subsequently through the switch S7, the switch S2, and the capacitor C2 to the node N5, and flows from the node N5 thorough the inductor Lo1 to the node N7, and generates the output current signal Io at the node N7 to provide power to the load 102. In response to the input current signal IIN2 generating the output current signal Io to provide power to the load 102, the voltage signal VC2 keeps increasing. Then, the charged capacitor C1 discharges to generate the current signal ID1. The current signal ID1 flows from the capacitor C1 through the switch S3, the node N5, and the inductor Lo1 and generates the output current signal Io to provide power to the load 102, and flows from the load 102 through the switch S6 and the node N6 to the capacitor C1 to form a loop. In response to the capacitor C1 discharging, the voltage signal VC1 keeps decreasing. In the meantime, the induced current of the inductor Lo2 provides power to the load 102. After the induced current of the inductor Lo1 flowed through the load 102, the induced current flows through the switch S6 to form a loop. At this moment, the voltage signal VC2 keeps increasing, and the voltage signal VC1 keeps decreasing, the voltage level VC12 remains the same as the voltage level of the input voltage signal VIN.

Then, at time T4, each of the signals Vgs_S1, Vgs_S4, and Vgs_S5 switches to the voltage level V1, such that each of the switches S1, S4, and S5 is turned on. Each of the signals Vgs_S2, Vgs_S3, and Vgs_S6 switches to the voltage level V0, such that each of the switches S2, S3, and S6 is turned off. At this moment, the power converter 900 completes a duty ratio of the switches S1 and S2 in a period between times T0 to T4.

In some embodiments, the operation of the power converter 900 during a period between times T4 to T5 in FIG. 10 can be referred to the operation in FIG. 11A and the period Q1, the similar parts of the operation are not repeated herein for simplicity. When the power converter 900 has completed the duty cycles of the switches S1 and S2, the power converter 600 subsequently repeats the next duty cycle of the switches S1 and S2. In some embodiments, the operation of the power converter 600 after time T9 can be extended to multiple operations similar to the periods Q1-Q4, but the present disclosure is not limited to the operation between the periods Q1-Q4.

In the embodiments of the present disclosure, compared to other approaches, the power converters 100 and 400 can achieve the purpose of blocking the reverse current inrushes generated from the reverse current signal IREV that imposed to the input power source 101 by arranging the switches S7 and S8 that are connected in series to the switches S1 and S2 and by controlling the turning on and turning off of the switches S7 and S8. The power converter 600 can achieve the purpose of blocking the reverse current inrushes generated from the reverse current signal IREV that imposed to the input power source 101 by arranging the switches S7 and S8 that are connected in series to the capacitors C1 and C2 and by controlling the turning on and turning off of the switches S7 and S8. The power converter 900 can achieve the purpose of blocking the reverse current inrushes generated from the reverse current signal IREV that imposed to the input power source 101 by arranging the switch S7 that is connected in series between the switches S1 and S2 and by controlling the turning on and turning off of the switch S7. In addition, the power converters 100, 400, 600 and 900 can depress the voltage signals VC1 and VC2 of the capacitors C1 and C2, such that the voltage signals VC1 and VC2 can effectively be decreased. In the circumstance that the voltage level VINL of the input voltage signal VIN is four times lower than the voltage level of the voltage signal Vo, the power converters 100, 400, 600, and 900 of the present disclosure can effectively achieve the purpose of lowering the voltage of the capacitor.

Although the present disclosure has been described in considerable detail with reference to certain embodiments thereof, other embodiments are possible. Therefore, the spirit and scope of the appended claims should not be limited to the description of the embodiments contained in the present disclosure.

It will be apparent to those skilled in the art that various modifications and variations can be made to the structure of the present disclosure without departing from the scope or spirit of the disclosure. In view of the foregoing, it is intended that the present disclosure cover modifications and variations of the present disclosure provided they fall within the scope of the following claims.

What is claimed is:

1. A power converter, comprising:
a first switch coupled to an input power source, input power source configured to generate an input current signal;
a second switch coupled to the input power source;
a third switch coupled to the first switch;
a fourth switch coupled to the second switch; and
a plurality of inductors coupled to each of the first switch, the second switch, the third switch, and the fourth switch,
wherein when the second switch is turned off, and the fourth switch is turned on, the third switch is turned off, and
when each of the first switch, the third switch, and the fourth switch is turned on, the plurality of the inductors generate an output current signal according to the input current signal to provide power to a load.

2. The power converter of claim 1, further comprising:
a first capacitor coupled to each of the first switch and the third switch in series; and
a second capacitor coupled between the second switch and the fourth switch in series.

3. The power converter of claim 2, wherein when each of the first switch, the second switch, and the third switch is turned on, the input current signal is configured to charge each of the first capacitor and the second capacitor.

4. The power converter of claim 2, wherein when the second switch is turned off, and when a voltage level of a sum of a voltage signal of two terminals of the first capacitor and a voltage signal of two terminals of the second capacitor is equal to a voltage level of a voltage signal of the input power source, the third switch is turned on.

5. The power converter of claim 2, wherein when the second switch and the third switch are turned off, and when the fourth switch is turned on, the first capacitor and the second capacitor are configured to discharge to the load.

6. The power converter of claim 2, further comprising:
a fifth switch coupled to the first switch; and
a sixth switch coupled between the second switch and the fourth switch,
wherein when the first switch is turned off, and the fifth switch is turned on, the sixth switch is turned off, and
when the second switch, the third switch, and the fifth switch are turned on, the output current signal is generated to provide power to the load according to the input current signal.

7. The power converter of claim 6, wherein
the first capacitor is coupled between the third switch and the fourth switch, and
the second capacitor is coupled between the fifth switch and the sixth switch.

8. The power converter of claim 7, wherein
when each of the second switch, the fifth switch, and a seventh switch coupled to the plurality of the inductors and the load is turned on, each of the third switch and sixth switch is turned off, and
when the second switch and the fifth switch are turned on, the fourth switch and the first switch are turned off.

9. The power converter of claim 8, wherein
when the fifth switch is turned off, and when each of the third switch and the sixth switch remains turned on, a voltage level of a sum of a voltage signal of two terminals of the first capacitor and a voltage signal of two terminals of the second capacitor is increasing, and
when each of the third switch, the fifth switch, and the sixth switch is turned off, the voltage level of the sum is decreased to a voltage level of the input power source.

10. The power converter of claim 2, further comprising:
a fifth switch coupled to the first switch; and
a sixth switch coupled to the third switch,
wherein when the first switch is turned off, and the fifth switch is turned on, the sixth switch is turned off, and
when the second switch, the third switch and the fifth switch is turned on, the output current signal is generated to provide power to the load according to the input current signal.

11. The power converter of claim 10, wherein
the first capacitor is coupled between the first switch and the fourth switch, and
the second capacitor is coupled between the second switch and the fifth switch.

12. The power converter of claim 11, wherein
the third switch is coupled to the input power source, and the third switch is coupled between the first switch and the input power source, and
the sixth switch is coupled to the input power source, and the sixth switch is coupled between the second switch and the input power source.

13. A method for controlling a power converter, comprising:
turning on a first switch and a second switch coupled to an input power source to generate an input current signal;
turning on a third switch coupled to the first switch, configured to charge a first capacitor and a second capacitor;
when the second switch being turned off, and when a fourth switch coupled to the second switch being turned on, turning off the third switch; and
when each of the first switch, the third switch, and when the fourth switch being turned on, an output current signal is generated to provide power to a load according to the input current signal.

14. The method of claim 13, further comprising:
when the second switch being turned off, and when a voltage level of a sum of a voltage signal of two terminals of the first capacitor and a voltage signal of two terminals of the second capacitor being equal to a voltage level of a voltage signal of the input power source, turning on the third switch.

15. The method of claim 13, further comprising:
when each of the first switch, the second switch, and the third switch being turned on, charging each of the first capacitor and the second capacitor by the input current signal, and
when the second switch and the third switch being turned off, and when the fourth switch being turned on, the first capacitor and the second capacitor discharging to the load.

16. The method of claim 13, further comprising:
when each of the second switch, a fifth switch coupled to the first switch, and a seventh switch coupled to the plurality of inductors and the load being turned on, turning off each of the third switch and sixth switch, and
when the second switch and the fifth switch being turned on, turning off the fourth switch and the first switch.

17. A power converter, comprising:
a first switch coupled to an input power source, the input power source configured to generate an input current signal;
a second switch coupled to the input power source;
a third switch coupled to each of the first switch and the second switch;
a fourth switch coupled to the second switch; and
a fifth switch coupled to the first switch,
wherein when the first switch is turned off, and when the fifth switch is turned on, the third switch is turned off, and
when each of the first switch, the third switch, and the fourth switch is turned on, an output current signal is generated by a plurality of inductors according to the input current signal.

18. The power converter of claim 17, further comprising:
a first capacitor coupled between the first switch and the fourth switch in series; and
a second capacitor coupled between the second switch and the fifth switch in series,
wherein when each of the first switch, the second switch, and the third switch is turned on, the input current signal is configured to charge each of the first capacitor and the second capacitor, and
when the first switch and the third switch are turned off, and when the fifth switch is turned on, the first capacitor and the second capacitor are configured to discharge to a load.

19. The power converter of claim 18, wherein when a voltage level of a sum of a voltage signal of two terminals of the first capacitor and a voltage signal of two terminals of the second capacitor is equal to a voltage level of a voltage signal of the input power source, the third switch is turned on.

20. The power converter of claim 17, wherein the third switch is coupled between the first switch and the second switch, and the third switch is coupled is further coupled to the input power source configured to receive the input current signal.
